(19) United States
(12) Patent Application Publication
(10) Pub. No.: US 2010/0017392 A1
(43) Pub. Date: Jan. 21, 2010

(54) Intent match search engine

(76) Inventor: Jianwei Dian, Plano, TX (US)

Correspondence Address: Jianwei Dian, 3529 Stroll Road, Plano, TX, 75025, US

(21) Appl. No.: 12/460,433

(22) Filed: Jul. 17, 2009

Related U.S. Application Data
(60) Provisional application No. 61/135,317, filed on Jul. 18, 2008.

(51) Int. Cl. G06F 17/30

(52) U.S. Cl. 707/5; 707/6; 707/E17.109; 707/E17.008

(57) ABSTRACT

Method and apparatus for a query based search engine that searches a database of linked documents. In some embodiments, the method and apparatus computes reliability degrees of the documents, abstracts each document to generate its abstracts, provides a search query interface so that a user can use to enter a search query, processes the search query to generate an intent match criterion, identifies matched documents according to the generated intent match criterion, computes relevance degrees of the matched documents, sets order of the matched documents, and presents the matched documents to the user according to the set order by displaying the following items for each matched document: a link to the matched document, an abstract of the matched document if there are abstracts of the matched document, and a match in the matched document if there are matches in the matched document.

### CROSS-REFERENCE TO RELATED APPLICATIONS

This application is based on and claims the benefit of U.S. provisional patent application, application No. 61/135,317, filed Jul. 18, 2008, entitled “INTENT MATCH SEARCH ENGINE”, the content of which is hereby incorporated by reference in its entirety.

### FEDERALLY SPONSORED RESEARCH OR DEVELOPMENT

Not Applicable

### SEQUENCE LISTING OR PROGRAM

Not Applicable

### NOMENCLATURE

In this disclosure, with respect to nomenclature, in addition to considering the context of how the terms are used, for the avoidance of doubt, the following terms are explained:

“Interface”—The term “interface” refers to the place and means by which independent systems interact or communicate with each other.

“User interface”—The term “user interface” refers to the aggregate of places and means by which the users of a product interact/communicate with the product.

“Graphics based interface (or, graphics interface)”—The term “graphics based interface” refers to an interface that realizes interactions or communications through visual graphics.

For example, the user interface of the search engine Google (http://www.google.com) is a graphics based interface. The interface provides an input box that a user can use to enter a search query.

“Sound based interface (or, sound interface)”—The term “sound based interface” refers to an interface that realizes interactions or communications through sound.

For example, a cell phone has an interface with a microphone as an input device. A user can use the cell phone by orally entering sound input through the microphone.

“Graphics and sound based interface (or, graphics and sound interface)”—The term “graphics and sound based interface” refers to an interface that contains a graphics based interface (as a sub-interface) and a sound based interface (as a sub-interface).

For example, a cell phone as a whole is an interface for its users. The key pad and the display is a graphics based interface, and the microphone is a sound based interface.

“Data structure”—The term “Data structure” refers a place and means for storing data. In other words, it refers to a data set that stores data in a particular way (the “structure”).

“Document”—The term “document” refers to a digital file that contains information useful in some sense and is stored in some format. For example, a document can be in HTML format, Microsoft Word format, PDF format, or another format.

“Database”—The term “database” refers to a collection of documents that are related in some sense. A database is a common pool of information that is organized so that it can easily be accessed, managed, updated, etc.

“Hypertext”—The term “hypertext” refers to text on a (typically, computer) screen that will lead the user to other related information on demand. Hypertext represents a relatively recent innovation to user interfaces, which overcomes some of the limitations of written text. Rather than remaining static like traditional text, hypertext makes possible a dynamic organization of information through links and connections. Hypertext can be designed to perform various tasks; for instance, when a user clicks on somewhere in it, a bubble with a word definition may appear, a web page on a related subject may load, a video clip may run, or an application may open.

“Hyperlink”—The term “hyperlink” refers to a link from a hypertext document (or, file) to another section of the same document or to a different document, typically activated by clicking on a highlighted word, phrase, or image on the (typically, computer) screen.

“Internet”—The term “Internet” refers to the international computer network providing email and information from computers in educational institutions, government agencies, and industry, etc. accessible to the general public via modem links.

“World Wide Web” (or, WWW, the Web, the web)—The term “World Wide Web” refers to the widely used information system of interlinked hypertext documents on the Internet that provides facilities for documents to be connected to other documents by hyperlinks, enable the user to search for information by moving from one document to another. The World Wide Web can be viewed as a database of the web pages.

“HTML”—The term “HTML” stands for “Hypertext Markup Language”, which is a standardized system for tagging text files to archive font, color, graphic, and hyperlink effects on the World Wide Web pages.

“Web page” (or, webpage)—The term “web page” refers to a resource of information that is suitable for the World Wide Web and can be accessed through a web browser. This information is usually in HTML format, and may provide navigation to other web pages via hypertext links.

Web pages may be retrieved from a local computer or from a remote web server. The web server may restrict access only to a private network, e.g. a corporate intranet, or it may publish pages on the World Wide Web. Web pages are requested and served from web servers using Hypertext Transfer Protocol (HTTP).

“Web browser”—The term “web browser” refers to a software application which enables a user to display and interact with text, images, videos, music and other information typically located on a web page at a web site on the World Wide Web or a local area network. Text and images on a web page can contain hyperlinks to other web pages at the same or different web site. Web browsers allow a user to access quickly and easily information provided on many web pages by traversing these links.

Web browsers format HTML information for display, so the appearance of a web page may differ between browsers. Although browsers are typically used to access the World Wide Web, they can also be used to access information provided by web servers in private networks or content in file systems.

The most popular web browser is Microsoft's Internet Explorer (or, IE).

“URL”—The term “URL” stands for “Universal Resource Locator”, which is the address of a web page. For an example, the URL of the search engine Google's home page is http://www.google.com.

“Web site” (or, website)—The term “web site” refers to a collection of web pages, images, videos or other digital assets that is hosted on one or more web servers, usually accessible via the Internet.

“Anchor text”—The term “anchor text” refers to the text that appears highlighted in a hypertext link and that can be clicked to open the target web page. Anchor text usually gives the user relevant, descriptive or contextual information about the content of the link's destination web page.

“Search engine”—The term “search engine” refers to an information retrieval system designed to help find information stored on a computer system. Search engines help to minimize the time required to find information and the amount of information which must be consulted, akin to other techniques for managing information overload.

In this disclosure, the term “search engine” comprises both the software and the hardware that are necessary for the “search engine” to work. To be more specific, the “software” comprises machine recognizable and executable instructions that are implemented through some programming languages. Those instructions can be stored on digital storage media. When the instructions are executed, they will perform the functions of the “search engine.” The “hardware” comprises all hardware parts that are necessary for the software of the “search engine” to work properly, such as processors, digital memories, digital storages, extended digital storages, etc.

The most visible and popular search engines are web search engines that search for information on the World Wide Web.

“Database of linked documents”—The term “database of linked documents” refers to a database of documents in which there is means for a user to move from document in the database to another document in the database, and there is cross references among the documents in the database.

The “moving” from one document to another document is realized by “links” between the two documents. A link is a pointer in a first document which points to a second document. A user can retrieve the second document following the link in the first document. Sometimes, a link in a document can also point to a different section in the same document.

In a database of linked documents, not every document references every other document. It's just that some documents reference some other documents. Also, typically, if one document (the “referencing document”) references another document (the “referenced document”), then there is a link from the referencing document to the referenced document.

The World Wide Web is the most popular and known database of linked documents. Hyperlink is a means for a user to move from one web page (the “referencing web page”) to another web page (the “referenced web page”). Also, there is abundant cross references among the web pages in the World Wide Web.

A corporate intranet typically is also database of linked documents.

“Instructions”—The term “instructions” refers to machine recognizable and executable instructions. A “machine” typically is a computer.

“He”—To simplify descriptions, the term “he” is used to refer to a user of a search engine under discussion. The term “he” should be interpreted as a person of any gender, and also should be interpreted as a non-human machine, such as a computer, if the machine is the “user” of a search engine.

“Search query”—The term “search query” refers to a query that a user enters into a search engine to request information he needs.

“Query based search engine”—The term “query based search engine” refers to a search engine that provides a search query interface. A user of the search engine can enter a search query through the search query interface. The search engine checks into the relevant database (such as the World Wide Web) to find files that match the user's search query according some criteria set by the search engine. Finally, the search engine will present the matched files to the user in some forms.

Query based web search engines are the most popular query based search engines, and they are search engines that search for information on the World Wide Web.

“Intent match search engine”—This invention provides method and apparatus for a query based search engine. The “Intent match search engine” is the apparatus that performs the method.

### BACKGROUND OF THE INVENTION

A. Field of the Invention

The present invention relates generally to query based search engines that search a database of linked documents, such as the World Wide Web. More particularly, the present invention relates to how to identify the matched documents that most probably are desired by a user based on his search query, how to rank the matched documents and how to present the matched documents to the user.

B. Related Art of the Invention

Query based web search engines are the most popular query based search engines, and they are also representative of query based search engines. The present invention will be described in the context of query based web search engines for the sake of descriptions and explanations.

Currently popular query based web search engines, such as Google (http://www.google.com), can be termed as word match search engines (or, keyword search engines). A word match search engine is characterized by the criterion that it uses to match web pages to the user's search query: Find web pages that contain words in the user's search query (may be with some variations, such as matching phrases if the user includes the phrases in double quotes). That is, any web page that contains the words in the user's search query will be deemed a matched web page with respect to the user's search. (If the search engine can't find web pages that contain all the words in the search query, it may try to find web pages that contain most of the words or some of the words in the search query, depending on how the search engine sets the criteria.)

Google is the most popular word match search engine, and it's also representative of word match search engines. Thus, throughout the descriptions and explanations, Google will be used when the differences between currently popular query based search engines and the intent match search engine of the present invention are described, and when the disadvantages of currently popular query based search engines and the advantages of the intent match search engine of the present invention are described. This is solely for the sake of descriptions and explanations. It should not be construed as limiting the scope of the present invention.

Below is how Google works:

Google has a web crawler which is a program that browses the World Wide Web periodically in a methodical and automated manner. The web crawler browses the World Wide Web and creates a copy of each web page that it visits. For each web page, various aspects of information about that web page are stored, such as the title of the web page, the content on the web page, the hyperlinks on the web page with their corresponding anchor text, etc. Those stored web pages are called indexed web pages. When Google performs a search for a user's search query, it doesn't search the World Wide Web at the time of the user's search request, but searches the database of all the indexed web pages.

Google provides a search query interface which has an input box that a user can type in a search query (See http://www.google.com. Also see a similar search query interface in FIG. 1). After Google receives a search query from a user, it checks into its database of all the indexed web pages to identify the web pages that contain words in the search query (may be with some variations, such as matching phrases if the user includes the phrases in double quotes).

After identifying the web pages that contain the words in the search query, which are called the matched web pages, the next step is to present the matched web pages to the user. It's a challenge for any search engine to decide which matched web pages to present first (that is, on the top.) Google uses a quantitative measure called PageRank to rank all its indexed web pages. It presents the matched web pages according to their PageRank values. To be specific, it presents the matched web pages from the top to the bottom with the PageRank values from the largest to the smallest. When Google presents a matched web page it displays a hyperlink to the web page and some exerted texts on the web page that contain the words in the search query.

Google has various disadvantages. Below are three of the disadvantages.

1) The criterion that Google uses to match web pages to a search query has disadvantages.

Web pages that simply contain words in the search query may not be of interest to the user at all. For example, suppose a user wants to find contact information of a person named Jianwei Dian. He enters the search query <contact information of Jianwei Dian>. A web page that contains the words “contact”, “information”, “Jianwei” and “Dian” may not contain any contact information about Jianwei Dian, such as Jianwei Dian's telephone numbers, mailing addresses or email addresses. Thus, that web page is of no interest to the user at all. (Note that Google normally ignores words like “of”, “for”, “the”, etc.)

Here and in what follows, “<” and “>” are used to indicate a search query. For the example of <contact information of Jianwei Dian>, the user's search query is “contact information of Jianwei Dian”.

For the search example <contact information of Jianwei Dian>, the very first matched web page that Google presented was:
“NA Digest. V. 02, #19 For further information please contact . . . Jianwei Dian and R. Baker Kearfott On the Complexity of Isolating Real Roots and Computing with Certainty the . . . www.netlib.org/netlib/na-digest-html/02/v02n19.html—24k—Cached—Similar pages”

Here, “NA Digest, V. 02, #19” is a hyperlink pointing to the actual web page www.netlib.org/netlib/na-digest-html/02/v02n19.html. The web page www.netlib.org/netlib/na-digest-html/02/v02n19.html does contain the words “contact”, “information”, “Jianwei” and “Dian”, but it doesn't contain any contact information about Jianwei Dian. (It will be shown later below where the words “contact”, “information”, “Jianwei” and “Dian” came from on that web page.)

If a web page contains the exact phrase “contact information of Jianwei Dian”, then that web page may be of high interest to the user. However, if the user tries to match the exact phrase with the search query <“contact information of Jianwei Dian”> by including the phrase in double quotes in the search query, then it may well happen that Google returns nothing.

2) The method that Google uses to rank matched web pages has disadvantages.

Google's ranking of web pages, the PageRank, is based on the “citation” data on the web. Here, “citation” refers to the cross references that web pages on the World Wide Web make to one another, typically through hyperlinks. For example, on a tourist information web page, there may be information about a hotel and a hyperlink to the home page of that hotel. Then, it's said that there is a citation of the home page of the hotel on the tourist information web page.

The citation measure is a type of popularity measure of a web page, and it is independent of any search queries. The popularity measure more or less can be deemed as the reliability measure of a web page, since popular web pages normally are reliable sources of information. However, reliability of the information has nothing to do with relevance of the information with respect to the user's search intent. That is, how reliable the information on a web page is has nothing to do with whether the information contains what the user is looking for. Thus, for a particular search query, the matched web pages that have high reliability (or, popularity) rankings, or even the highest ranking, may not be of interest to the user at all. For the same search example <contact information of Jianwei Dian> mentioned above, a web page that contains the words “contact”, “information”, “Jianwei” and “Dian”, and that has a high PageRank may not contain any contact information about Jianwei Dian, and thus may not be of interest to the user at all.

For the search example <contact information of Jianwei Dian>, the very first web page that Google presented was www.netlib.org/netlib/na-digest-html/02/v02n19.html. This web page is from a reliable source (www.netlib.org), but it doesn't contain any contact information about Jianwei Dian.

3) The method that Google uses to present a matched web page has disadvantages.

The way that Google presents a matched web page is to display a hyperlink to the web page with its title, and some exerted texts on the web page that contain words in the search query. This method of presentation may make it difficult for a user to decide whether or not the web page is of high interest to him, if the user doesn't actually look into that web page.

Again, for the search example <contact information of Jianwei Dian>, the very first matched web page that Google presented was:
“NA Digest, V. 02, # 19 For further information please contact . . . Jianwei Dian and R. Baker Kearfott On the Complexity of Isolating Real Roots and Computing with Certainty the . . . www.netlib.org/netlib/na-digest-html/02/v02n19.html—24k—Cached—Similar pages”

Only judging from the display of the matched web page, the user can't decide whether the web page contains any contact information about Jianwei Dian. Actually, the web page doesn't contain any contact information about Jianwei Dian.
The exerted texts came from “. . . Early application is strongly advised. For further information please contact Dr Len Freeman, Department of Computer Science, . . . ”and “. . . Verifying Topological Indices for Higher Order-Rank Deficiencies Jianwei Dian and R. Baker Kearfott

On the Complexity of Isolating Real Roots and Computing with Certainty the Topological Degree B. Mourrain, N. M. Vrahatis and J. C. Yakoubsohn . . . ”

on that web page.

The above are some disadvantages of Google.

Query based search engines, such as Google, are widely used by people for web search. Haying seen the above disadvantages of word match search engines, it will be very useful and valuable if a new type of query based search engine can be invented to avoid the above disadvantages of word match search engines.

C. Objects and Advantages of the Invention

The present invention provides a method and apparatus for a query based search engine, which is termed as intent match search engine. The intent match search engine overcomes the disadvantages of word match search engines that are described in “B. Related Art of the Invention”.

The intent match search engine of the present invention is different from word match search engines in the following aspects: How the intent match search engine matches web pages to a search query, how the intent match search engine ranks the matched web pages, and how the intent match search engine presents a matched web page to the user.

Comparing with Google and its disadvantages described in “B. Related Art of the Invention”, the objects and advantages of the intent match search engine of the present invention are:

1) The criterion that the intent match search engine uses to match web pages to a search query is different and has advantages.

After receiving a user's search query, when searching the indexed web pages to identify the matched web pages, instead of simply matching the words in the user's search query, the intent match search engine does analysis of the search query to identify the user's search intent, and then tries to find the web pages that are most relevant to the user's search intent.

For the search example <contact information of Jianwei Dian>, the intent match search engine will try to find web pages that contain both the person's name “Jianwei Dian” (or, “Dian, Jianwei”, or the alike), and telephone numbers, mailing addresses, email addresses or other types of contact information, especially if the telephone numbers, mailing addresses, email addresses or other types of contact information are immediately before or after the name “Jianwei Dian”. Those web pages more likely will contain what the user is really looking for. The matched web pages don't need to contain the word “contact” or “information”.

By matching the user's real search intent, the intent match search engine more likely will find web pages that contain what the user is really looking for.

2) The method that the intent match search engine uses to rank matched web pages is different and has advantages.

After identifying matched web pages, when ranking the matched web pages, the intent match search engine takes into consideration of both the relevance degrees and the reliability degrees of the web pages. The relevance degree is a measurement of how relevant the information on a web page is to the user's search intent. The reliability degree is a measurement of how reliable a web page is as a source of information. The intent match search engine will present to the user at the top the most relevant and reliable web pages.

With considering both the relevance and reliability of the matched web pages, the intent match search engine more likely will give high rankings to the web pages that both contain the information the user is looking for and are reliable sources of information. This saves the user's time, since the few top web pages or even the very first web page may already contain what the user is looking for and is also the most reliable source of information. The user doesn't need to navigate through a lot of matched web pages before he finds what he is looking for.

3) The method that the intent match search engine uses to present a matched web page is different and has advantages.

The intent match search engine contains a method to abstract web pages. The abstracts of a web page tell people what a web page is mainly about, just like the abstract of an article in a professional journal tells people what the article is mainly about. When presenting a matched web page, the intent match search engine will present the title of the web page as a hyperlink to the web page, an abstract of the web page and some exerted texts on the web page that likely contain what the user is looking for.

With this method of presenting the matched web pages, without the need to actually navigate through a web page, the user is more likely able to judge whether the web page contains what he is looking for, since the abstract of the web page provides the user additional information about what that web page is mainly about. This saves the user's time.

Other objects and advantages of the present invention are:

(4) The intent match search engine is able to provide advertisements that are more likely relevant to the user's needs.

As mentioned above, the intent match search engine analyzes the user's search query to determine what the user is really looking for. Thus, the intent match search engine knows the user's needs. With this, the intent match search engine will be able to provide advertisements that are most relevant to the user's needs.

Further objects and advantages of the present invention will become apparent from a consideration of the drawings and ensuing descriptions.

Because of its advantages described above, the intent match search engine of the present invention is superior to the currently popular word match search engines, such as Google.

### SUMMARY

Method and apparatus for a query based search engine that searches a database of linked documents. In some embodiments, the method and apparatus computes reliability degrees of the documents, abstracts each document to generate its abstracts, provides a search query interface so that a user can use to enter a search query, processes the search query to generate an intent match criterion, identifies matched documents according to the generated intent match criterion, computes relevance degrees of the matched documents, sets order of the matched documents, and presents the matched documents to the user according to the set order by displaying the following items for each matched document: a link to the matched document, an abstract of the matched document if there are abstracts of the matched document, and a match in the matched document if there are matches in the matched document.

### DRAWINGS

FIG. 1 shows an example of a graphics based search query interface that the intent match search engine can provide to users.

FIG. 2 shows a general block diagram which illustrates the method for the intent match search engine.

FIG. 3 shows the flowchart of abstracting a web page.

FIG. 4 shows the flowchart of computing historical degrees of the web pages that a user visited with respect to the particular user and after a particular search.

FIG. 5 shows the flowchart of handling one search query.

### DETAILED DESCRIPTION

As mentioned in the “NOMENCLATURE”, this invention provides method and apparatus for a query based search engine. The intent match search engine is the apparatus that performs the method. Thus, all the descriptions apply to both the method and apparatus for the query based search engine, regardless of whether the descriptions are made in the context of the method or in the context of the intent match search engine.

The intent match search engine of the present invention typically is used to search a database of linked documents, and the database of linked documents is typically the World Wide Web.

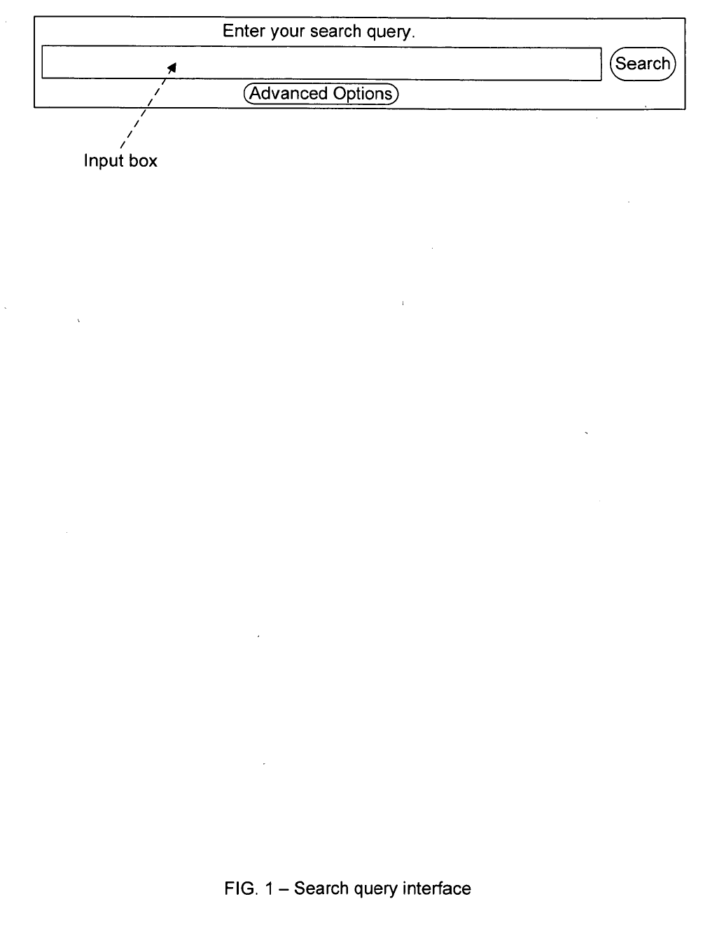

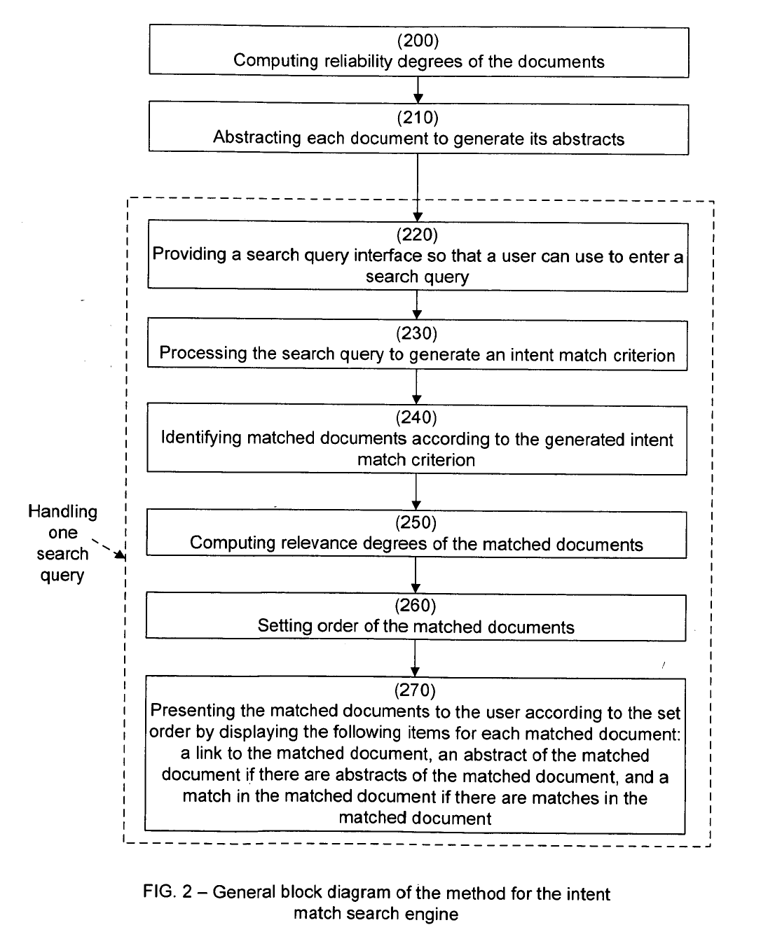

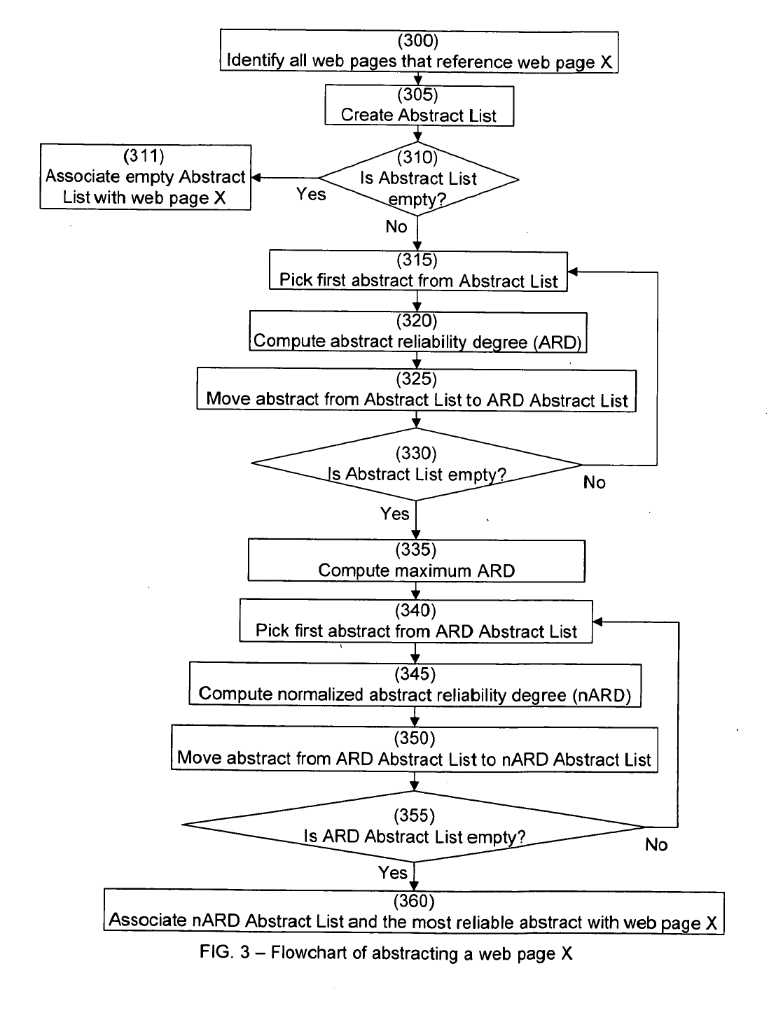

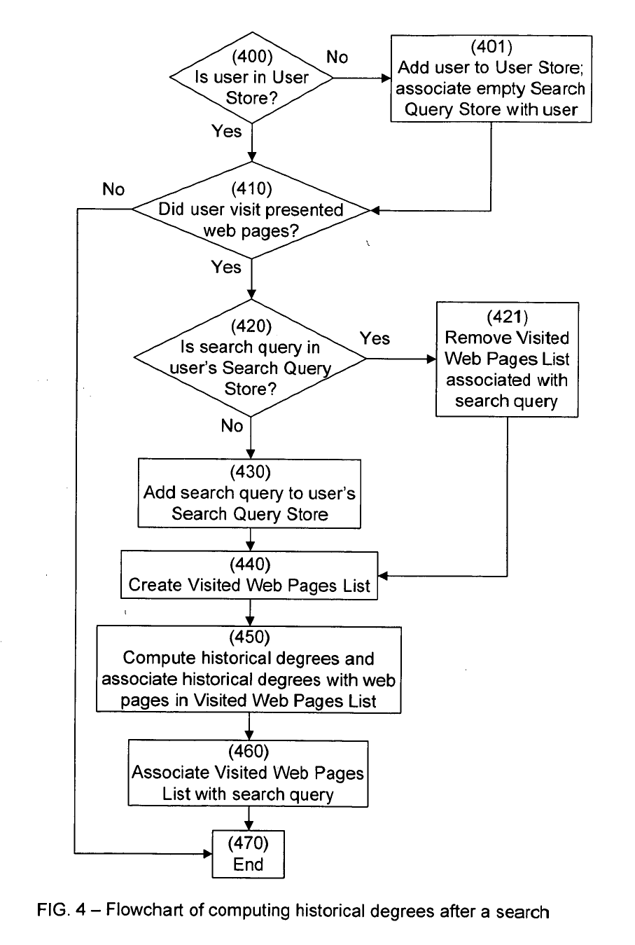

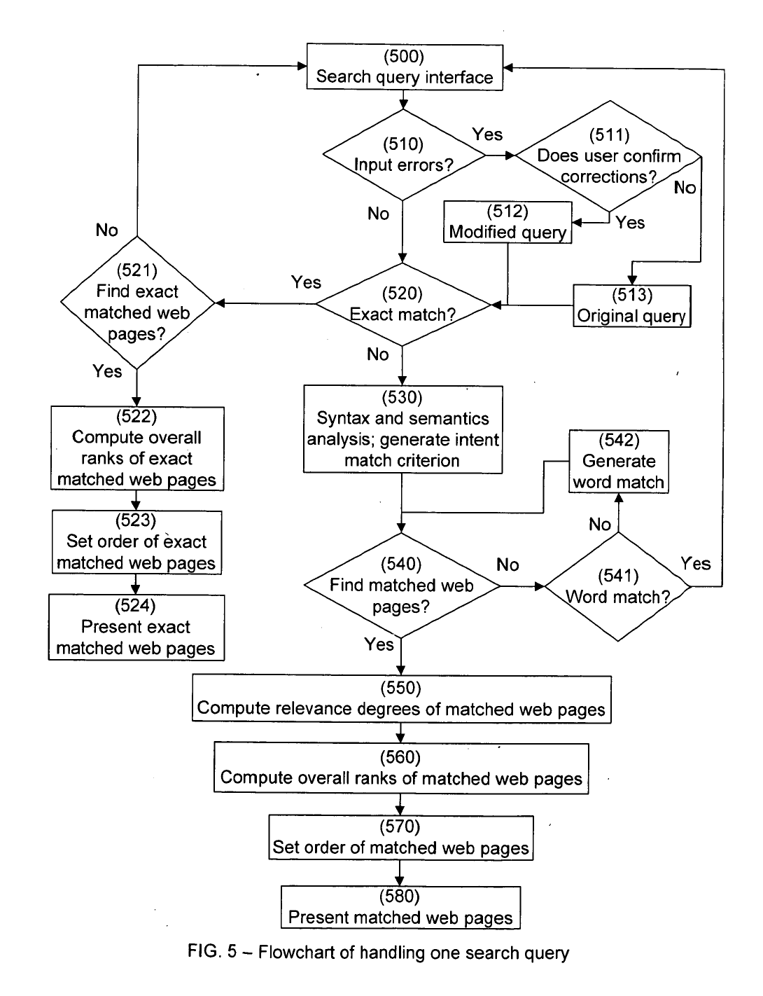

Details of the present invention will be described in four sections: A. General Description (FIG. 2); B. Preferred Embodiment (FIG. 1, FIG. 3, FIG. 4, and FIG. 5); C. Variations of the Preferred Embodiment; and D. Conclusions, Ramifications and Scope of the Present Invention.

The blocks in FIG. 2, FIG. 3, FIG. 4 and FIG. 5 represent sets of machine (typically computer) recognizable and executable instructions that are implemented through some programming languages, such as Java, C, C++, Fortran, Shell scripts or other types of programming languages. Those instructions can be stored on a digital storage medium, such as a hard disk, a removable CD, DVD or USB flash drive, or other types of digital storage media. When the instructions of a block are executed, they will perform the functions of that particular block.

### A. General Description (FIG. 2)

Typically, a search engine doesn't operate on the original database of linked documents. A search engine typically makes a copy of every document in the original database of linked documents and stores all the copies in a local database. A copy of the original document is called an “indexed document,” and the database of all the indexed documents is called an “indexed database.” (Sometimes, an indexed document is also called “cached” document.) The indexed database may also associates with each indexed document extra information about the corresponding original document. The extra information can be some characteristics of the original document that the search engine deems useful for handling a user's search. The above process is called indexing of the original database. Of course, if the original database that the search engine searches is already an indexed database, then the indexing process is not necessary. For example, if the implementer of the search engine is also the creator of the original database, then the database can be already indexed when it is created.

When a user uses the search engine, the search engine actually searches its local indexed database and then presents links to the original documents. In other words, when performing the search, the search engine actually operates on the indexed database. Google is such a search engine. That is, Google searches its indexed database.

Google has a crawling and indexing method that can be used to crawl and index the web pages on the World Wide Web. Using that method, Google can generate a database of indexed web pages. At the time of handling a user's search query, Google doesn't directly search the World Wide Web, but instead, it searches its local database of all the indexed web pages (the indexed World Wide Web). Similar or new crawling and indexing methods can be used to index a database of linked documents, such as a corporate intranet.

The reason for indexing the original database is that the search of the indexed database typically is faster than search of the original database of linked documents, since the original documents typically reside on remote computers, but the indexed documents can reside on local computers that are much closer to the intent match search engine and thus much faster to access.

It's preferred and typical that the intent match search engine of the present invention be implemented to operate on an indexed database of the original database of linked documents (such as abstracting the documents, identifying the documents that match user's search intent, etc. that will be described below.) However, the intent match search engine can be implemented to operate directly on the original database of linked documents. In what follows and in the claims, the term “document” represents a document in the original database if the intent match search engine is implemented to operate directly on the original database, and the term “document” represents an indexed document in the indexed database if the original database of linked documents is indexed, and the intent match search engine is implemented to operate on the indexed database. When it's necessary to distinguish, “original document” and “indexed document” will be used to explicitly represent a document in the original database and a document in the indexed database, respectively.

FIG. 2 is a block diagram illustrating a flowchart of the method for the intent match search engine in the most general form. The functions of each block in FIG. 2 are described below.

Block (200) computes reliability degrees of the documents. The reliability degree of a document is an indicator of how reliable the information in the document is. The intent match search engine would try to provide to its users the most reliable information.

Block (210) abstracts each document to generate its abstracts. To abstract a document is to make one or more summaries of the contents in that particular document. The result of abstracting a document is abstracts (that is, summaries) of the contents in that particular document. The abstracts of the documents will be used in handling a user search query.

The blocks (200) and (210) can be performed offline if the original database of linked documents is indexed and the intent match search engine is implemented to operate on the indexed database. (In this disclosure, “offline” means while not directly controlled by or connected to external networks, such as the Internet.)

The blocks (220), (230), (240), (250), (260) and (270) are performed when the intent match search engine handles one search query from a user, or in other words, when a user actually uses the intent match search engine to perform a search of the database of linked documents.

Block (220) provides a search query interface so that a user can use to enter a search query. Providing a search query interface is one of the characteristics of query based search engines.

Block (230) processes the search query to generate an intent match criterion. The generated intent match criterion is a criterion for deciding which documents match the user's search intent that is described by the user's search query. Those documents are called matched documents.

Block (240) identifies matched documents according to the generated intent match criterion.

Block (250) computes relevance degrees of the matched documents. The relevance degree of a document is an indicator of how relevant the information in the document is with respect to the user's search intent. The intent match search engine would try to provide to its users the most relevant information with respect to the user's search intent.

Block (260) sets order of the matched documents. That is, block (260) decides which matched document to present to the user first, which second, which third, and so on and so forth. In setting the order of the matched documents, the intent match search engine will make use of the reliability degrees and relevance degrees of the matched documents. It may use more measurements of the matched documents depending on actual implementations.

Block (270) presents the matched documents to the user according to the set order by displaying the following items for each matched document: a link to the matched document, an abstract of the matched document if there are abstracts of the matched document, and a match in the matched document if there are matches in the matched document. In general, a “match” is the contents in a document that satisfy certain criterion set by the intent match search engine with respect to the user's search intent. Greater details will be described in the preferred embodiment.

The above is the general description of the method for the intent match search engine. Greater details will be further described below in the preferred embodiment.

### B. Preferred Embodiment (FIG. 1, FIG. 3, FIG. 4, and FIG. 5)

For the sake of readers' understanding, the details are described using the World Wide Web as an embodiment of the “database of linked documents,” since the World Wide Web is the most popular and known database of linked documents, and a lot of people encounter them almost everyday. Using them will enhance readers' understanding of the invention and thus enable readers better appreciate the disclosure. However, it should be understood that using the World Wide Web as an embodiment of the database of linked documents should not be construed as limiting the scope of the present invention.

Also, similar to the meaning of the term “document” described above, in what follows, the term “web page” represents an original web page on the World Wide Web if the intent match search engine is implemented to operate directly on the World Wide Web, and the term “web page” represents an indexed web page if the World Wide Web is indexed and the intent match search engine is implemented to operate on the indexed World Wide Web (or in other words, the database of indexed web pages.) When it's necessary to distinguish, “original web page” and “indexed web page” will be used to explicitly represent an original web page on the World Wide Web and an indexed web page in the indexed World Wide Web, respectively.

The preferred embodiment will be described in four parts: B-1: Compute Reliability Degrees of the Web Pages; B-2: Abstract the Web Pages; B-3: Compute Historical Degrees after Each Search; and B-4: Handling One Search Query.

### B-1: Compute Reliability Degrees of the Web Pages

For every web page, a reliability degree will be computed which represents how reliable that particular web page is (or in other words, how reliable the information on that particular web page is).

Currently popular web search engines have ranking mechanisms for their web pages. For example, Google computes a PageRank for every web page. Google's PageRank is based on the citations among web pages on the World Wide Web. Google's PageRank basically is the measurement of the popularity degree of a web page on the World Wide Web. Popularity has some correlations with reliability. Normally, the more popular a web page is, the more reliable the web page will be. Thus, the popularity of a web page can be deemed (to some extent) as a measurement of the reliability of that web page.

The ranking mechanism of Google, namely the PageRank ranking mechanism, or another ranking mechanism, can be used to compute the reliability degrees of the web pages. After that, the intent match search engine will perform normalization of the reliability degrees. The process is described below.

Suppose that there are totally N web pages WP₁, WP₂, . . . , WP_{N}. Suppose the reliability degrees (WPReliaD) of the N web pages are computed as WPReliaD₁, WPReliaD₂, . . . , WPReliaD_{N} by applying a ranking mechanism such as Google's PageRank ranking mechanism. Here all the reliability degrees are positive numbers. If the reliability of a web page is 0, such as WPReliaDᵢ=0, then it can be perturbed a little bit to be a positive number. To be specific, for WPReliaDᵢ=0, WPReliaDᵢ will be forced to be equal to a very small positive number: WPReliaDᵢ=epsilon, where “epsilon” is a very small positive number, such as epsilon=0.0000001. Thus, from now on, it's assumed that all reliability degrees are positive numbers.

After all the reliability degrees WPReliaD₁, WPReliaD₂, . . . , WPReliaD_{N} are computed, the normalized reliability degrees (nWPReliaD) of the web pages can be computed according to the following formula:

nWPReliaD₁=WPReliaD₁/max(WPReliaD₁, WPReliaD₂, . . . , WPReliaD_{N}),

nWPReliaD₂=WPReliaD₂/max(WPReliaD₁, WPReliaD₂, . . . , WPReliaD_{N}),

nWPReliaD_{N}=WPReliaD_{N}/max(WPReliaD₁, WPReliaD₂, . . . , WPReliaD_{N}).

In this disclosure, “max(X₁, X₂, . . . , X_{N})” denotes the maximum number among the numbers X₁, X₂, . . . , X_{N}. Also, in this disclosure, if X₁ and X₂ are two numbers, then the symbol “/” in “X₁/X₂” denotes a division, and the symbol “*” in “X₁*X₂” denotes a multiplication.

It's obvious that, after the normalization, the largest normalized reliability degree is always 1, and all the normalized reliability degrees are between 0 and 1. To distinguish, the reliability degrees before the normalization are called non-normalized reliability degrees.

After the normalized reliability degrees are computed, each normalized reliability degree is associated with the corresponding web page. The normalized reliability degree of a web page is a measurement of the reliability of the information on the web page.

The normalized reliability degrees can be computed offline, and they are a, independent of any user searches. Also, the normalized reliability degrees should be computed periodically to reflect the fact that new web pages are constantly added to the World Wide Web, and changes may often be made to existing web pages.

### B-2: Abstract the Web Pages (FIG. 3)

To abstract a web page is to make summaries of the contents on that particular web page. The result of abstracting a web page is abstracts (or, summaries) of the contents on that particular web page. The abstracts tell what the contents on the web page are mainly about. The present invention provides a method to do abstracting of web pages. The method utilizes the abundant cross references available on the World Wide Web.

FIG. 3 shows the detailed flow of processes for abstracting a web page. For simplicity, the web page to be abstracted is called “web page X” or simply “X.” To simplify descriptions, the method and the apparatus that perform the abstracting of all the web pages are called the “Abstractor”. That is, the Abstractor can be interpreted as the method, and the Abstractor can also be interpreted as the apparatus (a set of computer recognizable and executable instructions that are implemented through some programming languages and that are stored on a digital medium).

On the World Wide Web, there are abundant cross references among the web pages. The web page that references another web page is called the referencing web page, and the web page that the referencing web page references is called the referenced web page. Typically, the referencing web page either contains one or more hyperlinks to the referenced web page, or contains the URL of the referenced web page.

At (300), the Abstractor identifies all web pages that reference the web page X and creates a list of referencing web pages.

When a referencing web page references another web page, on the referencing web page, there may be a hyperlink that points to the referenced web page, and often there are also anchor text and texts around the anchor text that describe some aspects of the contents on the referenced web page.

For example, on a company's home page (web page A), there is often a hyperlink called “Contact us.” The link points to another web page (web page B) that normally contains contact information of that company. If a person clicks on the anchor text “Contact us”, web page B will appear. This means that web page A contains a hyperlink to web page B, and “Contact us” is the anchor text. The anchor text “Contact us” is an abstract that web page A makes for web page B. Even if we don't actually look into web page B, we know from the abstract “Contact us” on web page A that web page B contains contact information.

There are also other types of references on the World Wide Web. There can be a sentence on a web page C that says “In addition to the vast resources on this site, Practical Parent Education provides schedules for parenting classes, conferences and information about its Family Resource Center lending library.” with “Practical Parent Education” as the anchor text and the hyperlink pointing to a web page D. Here, “Practical Parent Education provides schedules for parenting classes, conferences and information about its Family Resource Center lending library” is an abstract that web page C makes for web page D. The abstract tells people what information web page D contains.

There can be a sentence on a web page E that says “To make a gift donation, please click here”, with “click here” as the anchor text and the hyperlink pointing to a web page F. Here, “To make a gift donation” is an abstract that web page E makes for web page F.

On a web page G, there can be the URL of a web page H, like “http://www.xyz.com/abc”, with some explanation texts around the URL. The explanation texts would form an abstract that web page G makes for web page H.

For a particular web page X, there can be more than one web page that references it. The abstracts that the referencing web pages make for the web page X can be different. Each abstract may touch some aspects of the contents on the web page X.

It can happen that a referencing web page (for the web page X) can reference web page X more than once with different abstracts. In this case, the different abstracts are combined together to form a single abstract. That is, for each referencing web page for the web page X, there is only one abstract.

It can also happen that a referencing web page for the web page X doesn't have any anchor texts or explanation texts for the web page X. In this case, there is simply no abstract from the referencing web page for the web page X.

At (305), the Abstractor will analyze each of the referencing web pages and create one abstract and associates the abstract with the corresponding referencing web page. If a referencing web page doesn't have an abstract for the web page X, the Abstractor simply removes the web page from the list of referencing web pages.

It can happen that multiple referencing web pages have the same abstract. In this case, the Abstractor associates the abstract with a list of the referencing web pages in an order with the referencing web pages' normalized reliability degrees from the largest to the smallest.

For example, assume that there are m referencing web pages WP₁, WP₂, . . . , WPₘ that have a same abstract. Then, the Abstractor lists the web pages WP₁, WP₂, . . . , WPₘ in such a way that their corresponding normalized reliability degrees WPReliaD₁, WPReliaD₂, . . . , WPReliaDₘ satisfy WPReliaD₁≧WPReliaD₂≧ . . . ≧WPReliaDₘ. (In this disclosure, “≧” means “greater than or equal to”.)

After creating all the different abstracts, the Abstractor creates an Abstract List that contains all the abstracts, and each abstract is associated with a list of referencing web pages that make that particular abstract for the web page X. The list of referencing web pages associated with a particular abstract may contain only one referencing web page if only one referencing web page makes that particular abstract for the web page X.

After creating the Abstract List at (305), the Abstractor proceeds to (310) to check whether the Abstract List is initially empty. This can happen when none of the referencing web pages of the web page X makes abstract for the web page X. In this case, the Abstract List is initially empty, and the Abstractor proceeds to (311) to associate an empty abstract list with the web page X, which means the web page has no abstracts. This completes abstracting of the web page X.

At (310), if the Abstract List is not empty, then the Abstractor proceeds to (315) to pick up the first abstract from the Abstract List, which is denoted as abstract A.

After picking up abstract A from the Abstract List, the Abstractor proceeds to (320) to compute the abstract reliability degree (ARD) of abstract A.

In the present invention, the abstracts of a web page are not treated equally with respect to reliability. For example, if one abstract occurs on 10 different web pages that reference the web page X, but another abstract occurs on 1000 different web pages that reference the web page X, assuming all other conditions, such as the reliabilities of the referencing web pages themselves, are the same, then the second abstract should have higher reliability degree. Also, if one abstract occurs on a lowly reliable web page that references the web page X, but another abstract occurs on a highly reliable web page that references the web page X, assuming all other conditions are the same, then the second abstract should have higher reliability degree.

In computing the ARD of an abstract for the web page X, both the number of web pages that reference the web page X with that particular abstract, and the reliability degrees of the referencing web pages will be considered. In computation of the ARD of an abstract for the web page X, the number of occurrences of that particular abstract on the same web page that references X is not considered. In other words, whether that particular abstract occurs 3 times or 3000 times on the same referencing web page doesn't change the reliability degree of that particular abstract.

We know that, at (305), each abstract is associated with a list of referencing web pages with their normalized reliability degrees running from the largest to the smallest. Those referencing web pages reference the web page X with that particular abstract. Assume that the web pages that reference the web page X with abstract A are WP₁, WP₂, . . . , WPₘ, with corresponding normalized reliability degrees nWPReliaD₁, nWPReliaD₂, . . . , nWPReliaDₘ, where 1≦nWPReliaD, >nWPReliaD₂≧. . . ≧nWPReliaDₘ>0. Then the following formula can be used to compute the ARD of abstract A:

ARD=nWPReliaD₁^{I1}+nWPReliaD₂^{I2}+ . . . +nWPReliaDₘ^{Im},

where I1, I2, . . . , Im are positive integers with I1<=I2<= . . . <=Im. For example, they can be set as I1=1, I2=2, I3=3, . . . , Im=m, or they can be set as I1=1, I2=3, I3=4, . . . , Im=m+1. Regardless of what are the values of I1, I2, . . . , Im, these values can be preset and can be independent of web pages or their abstracts.

After computing ARD of abstract A at (320), the Abstractor proceeds to (325) to move abstract A from the Abstract List to another abstract list which is called ARD Abstract List. The ARD Abstract List is initially empty. Each abstract in the ARD Abstract List is associated with an abstract reliability degree, the computed ARD of that particular abstract.

After moving abstract A from the Abstract List to the ARD Abstract List, the Abstractor proceeds to (330) to check whether the Abstract List is empty.

At (330), if the Abstract List is not empty, then it means that there are still abstracts in the Abstract List whose abstract reliability degrees have not yet been computed. Then, the Abstractor proceeds back to (315) to repeat the processing of the first abstract in the Abstract List. This process repeats until the Abstract List is empty.

At (330), when the Abstract List is empty, it means that all the abstracts that are originally in the Abstract List have been moved to the ARD Abstract List, and an ARD has been associated with each of the abstracts. Then, the Abstractor proceeds to (335) to compute the maximum ARD. Assume that there are altogether p abstracts A₁, A₂, . . . , Aₚ in the ARD Abstract List with corresponding abstract reliability degrees ARD₁, ARD₂, . . . , ARDₚ. Then, the maximum ARD is denoted as max(ARD₁, ARD₂, . . . , ARDₚ).

After obtaining max(ARD₁, ARD₂, . . . , ARDₚ), the Abstractor will compute normalized abstract reliability degrees of all the abstracts A₁, A₂, . . . , Aₚ. The Abstractor will accomplish this according the following steps.

The Abstractor proceeds to (340) to pick up the first abstract from the ARD Abstract List, which is denoted as abstract B.

After picking up abstract B from the ARD Abstract List, the Abstractor proceeds to (345) to compute the normalized abstract reliability degree (nARD) of that particular abstract B according to the following formula:

nARD=ARD/max(ARD₁, ARD₂, . . . , ARDₚ),

where ARD is the abstract reliability degree of abstract B, and max(ARD₁, ARD₂, . . . , ARDₚ) is the maximum ARD computed at (335).

After computing nARD of abstract B, the Abstractor proceeds to (350) to move abstract B from the ARD Abstract List to another abstract list which is called nARD Abstract List. The nARD Abstract List is initially empty. Each abstract in the nARD Abstract List is associated with a normalized abstract reliability degree, the computed nARD of that particular abstract.

After moving abstract B from the ARD Abstract List to the nARD Abstract List, the Abstractor proceeds to (355) to check whether the ARD Abstract List is empty.

At (355), if the ARD Abstract List is not empty, then it means that there are still abstracts in the ARD Abstract List whose normalized abstract reliability degrees have not yet been computed. Then, the Abstractor proceeds back to (340) to repeat the processing of the first abstract in the ARD Abstract List. This process repeats until the ARD Abstract List is empty.

At (355), when the ARD Abstract List is empty, then it means that all the abstracts that are initially in the ARD Abstract List have been moved to the nARD Abstract List, and an nARD has been associated with each of the abstracts. Each abstract in the nARD Abstract List is called a reliability graded abstract, since a normalized reliability degree has been associated with the abstract. Then, the Abstractor proceeds to (360) to associate the final abstract list, which is the nARD Abstract List, with the web page X, and the Abstractor also associates with the web page X an abstract called “the most reliable abstract.”

The most reliable abstract is the abstract with the highest normalized abstract reliability degree. If there are two or more such abstracts with the same highest normalized abstract reliability degree, then, the most reliable abstract is the shortest abstract (the abstract that contains the least words). If there are two or more such shortest abstracts, then, the most reliable abstract is the one that has the least characters. If there are two or more such abstracts with the least characters, then, the most reliable abstract can be any of those abstracts.

By associating the nARD Abstract List and the most reliable abstract with the web page X, the Abstractor completes abstracting the web page X.

It's clear from the abstracting of the web page X that, after the abstracting of the web page X, either an empty abstract list is associated with the web page X or a non-empty abstract list is associated with the web page X. In this disclosure and in the claims, the “abstracts” of a document or a web page should be interpreted in the sense that there may be more than one abstract, only one abstract or no abstracts at all, depending on the abstract list that is associated with the document (or, web page.)

If a non-empty abstract list is associated with the web page X, then a normalized abstract reliability degree is associated with each abstract in the abstract list, and the most reliable abstract is associated with the web page X. (It should be rare that an empty abstract list is associated with a web page if the web page is popular.)

The normalized abstract reliability degree is a number between 0 and 1, and it represents how reliable its associated abstract is: The larger the nARD is, the more realizable the abstract is. Also, the most reliable abstract (or, abstracts) has nARD=1. Actually, the process of normalizing the abstract reliability degrees is to take the reliability degree of the most reliable abstract (the abstract having the maximum abstract reliability degree) as a basis of 1, and scale all the other abstract reliability degrees to between 1 and 0 based on the abstract reliability degree of the most reliable abstract.

The blocks (300) and (305) form an independent method for abstracting a document in a database of linked documents to generate abstracts of the document. (The other blocks are optional.) As already mentioned, the method utilizes cross references among the documents to generate the abstracts.

Abstracting of web pages can be performed offline for all the web pages. The abstracting of web pages is independent of any user's searches. After the abstracting, for each web page X, all the abstracts of that particular web page X and the corresponding nARD of each abstract will be obtained. All the abstracts with their corresponding nARDs will be associated with the web page X. The most reliable abstract is also associated with the web page X if there are abstracts associated with the web page. Furthermore, abstracting of the web pages need to be performed periodically to take into consideration of newly added web pages and changes in existing web pages.

In the present invention, in the method of abstracting a web page X, the web page X itself is not analyzed. Instead, what other web pages summarize about the web page X is analyzed. The cross references on the World Wide Web for a particular web page X are used for abstracting the web page X.

There may be software packages that analyze the content on a web page itself to abstract the web page. However, due to irregularities and complexities of contents on the World Wide Web, current software packages may not abstract a web page accurately. In contrast, the cross references on the World Wide Web are normally written by humans and thus are typically more accurate. By analyzing the cross references on the web, more accurate abstracts can be obtained.

### B-3: Compute Historical Degrees after Each Search (FIG. 4)

The intent match search engine stores users' historical search data and makes use of users' historical search data in ranking the web pages with respect to a particular search query.

The intent match search engine keeps a data structure called User Store. Every “user” that once used the intent match search engine is stored in the User Store. Here, a “user” can be identified by the IP address from which the searches are performed. (Of course, different methods can be used to identify the “user”.) In what follows, when talking about a “user” in the User Store, the “user” should be interpreted in this sense. In other words, if the “user” is identified by the IP address, then in the User Store, a “user” is actually an IP address.

For each user in the User Store, a data structure called Search Query Store is associated with the user. The Search Query Store stores all the search queries that particular user used to perform web searches. For each search query in the Search Query Store, a list of web pages called Visited Web Pages List is associated with the search query. For each web page in the Visited Web Pages List, a historical degree (nWPHistoD) is associated with the web page.

Whenever a user performs a search using the intent match search engine, the intent match search engine records the search relevant information about the user, the search query and the web pages (presented to the user by the intent match search engine) that the user actually visited for that particular web search, in the order that the user visited them, from the first one to the last one before the user completed the search. After the user completes his search (including visiting the web pages), the intent match search engine will compute the historical degrees of all the web pages that the user visited, with respect to that particular search query and for that particular user, and the intent match search engine places the various items in the User Store.

FIG. 4 shows the detailed steps for computing historical degrees of the web pages that a user visited after the user's search. Below are descriptions of the detailed steps.

To simply descriptions, the program that computes the historical degrees and updates the User Store is called the Recorder.

After a user completes a search, the Recorder checks into the User Store at (400) to see whether the user is already in the User Store.

At (400), if the Recorder finds that the user is already in the User Store, then the Recorder proceeds to (410) to check whether the user actually visited Any web pages presented to him by the intent match search engine.

At (400), if the user is not in the User Store, then the Recorder proceeds to (401) to add the user to the User Store and associate an empty Search Query Store with the user. Then, the Recorder proceeds to (410).

At this point, the Recorder has proceeded to (410) from some path.

At (410), the Recorder checks whether the user actually visited any web pages presented to him by the intent match search engine. If not, then the Recorder proceeds to (470) to end the entire process of updating the User Store for this particular search; if yes, then the Recorder proceeds to (420) to check whether the search query is already in the user's Search Query Store.

At this point, either the entire process has ended or the Recorder has proceeded to (420).

At (420), if the Recorder finds out that the search query is not in the user's Search Query Store, then the Recorder proceeds to (430) to add the search query to the user's Search Query Store, and then proceeds to (440) to create a list of the web pages (presented to the user by the intent match search engine) that the user actually visited. The list arranges the web pages in the order that the user actually visited. That is, the first web page is the web page that the user visited first, the second web page is the web page that the user visited second, and so on and so forth. This list is called the Visited Web Pages List. The Visited Web Pages List finally will be associated with the search query, and each web page in the Visited Web Pages List will have a historical degree. The process for doing this will be described later below.

At (420), if the search query is already in the user's Search Query Store, then the Recorder proceeds to (421) to remove the old Visited Web Pages List that was associated with the search query before. Then the Recorder proceeds to (440) to create the Visited Web Pages List containing the web pages (presented to the user by the intent match search engine) that the user actually visited with the new search. See descriptions above for how the order is arranged for the web pages in the Visited Web Pages List.

At this point, the Recorder has proceeded to (440) from some path and has created the Visited Web Pages List.

Here, for the sake of descriptions, assume Visited Web Pages List is {WP₁, WP₂, . . . , WPₘ}. According to how the order of web pages is arranged in the Visited Web Pages List described above, it means that the user actually visited m web pages WP₁, WP₂, . . . , WPₘ, and WP₁ is the first web page the user visited, WP₂ is the second web page the user visited, . . . , WPₘ is the m-th web page that the user visited.

After the Recorder creates the Visited Web Pages List at (440), it proceeds to (450) to compute historical degrees for all the web pages in the Visited Web Pages List and associate the historical degrees with the corresponding web pages in the Visited Web Pages List.

For the web pages WP₁, WP₂, . . . , WPₘ in the Visited Web Pages List, the Recorder can use the following formula compute their historical degrees (nWPHistoD):

nWPHistoDᵢ=1/(1+(m−i)*epsilon),

where i=1, 2, . . . , m, and epsilon is a positive number smaller than 1, such as epsilon=0.1. The currently preferred value of epsilon is 0.1.

The Recorder associates all the historical degrees with their corresponding web pages. That is, the Recorder associates nWPHistoDᵢ with the web page WPᵢ, where i=1, 2, . . . , m.

It's obvious that the very last web page that the user visited, which is WPₘ, has the highest historical degree of 1. The underline reason is that, usually, after a user finds what he is looking for, he will not look into any other web pages any more. Thus, the last web page that the user visited is the most probable web page that contains what the user was looking for.

After it computes historical degrees for all the web pages in the Visited Web Pages List and associates the historical degrees with the corresponding web pages in the Visited Web Pages List at (450), the Recorder proceeds to (460) to associate the Visited Web Pages List with that particular search query in the user's Search Query Store. Then, the Recorder proceeds to (470) to complete the entire process of computing the historical degrees and updating the User Store for this particular search.

It's obvious from the above descriptions that, even the search query was already in the user's Search Query Store, if the user did actually visit some web pages presented to him by the intent match search engine, the intent match search engine will update the User Store by creating a new Visited Web Pages List, computing and associating historical degrees with the web pages in the new Visited Web Pages List, and associating the new Visited Web Pages List with the search query in the user's Search Query Store.

### B-4: Handling One Search Query (FIG. 1 and FIG. 5)

How to compute normalized reliability degrees (nWPReliaD) of the web pages, how to abstract the web pages and how to compute historical degrees (nWPHistoD) of user visited web pages have been described above. The results obtained in the processes will be used in handling users' web searches. To be specific, the reliability degrees of the web pages, the abstracts of the web pages along with the abstracts' normalized abstract reliability degrees (nARD) and the historical degrees (nWPHistoD) of user visited web pages will be used in handling the user's web searches.

Like all query based search engines, such as Google, the intent match search engine of the present invention handles one search query at one time. FIG. 5 shows the detailed flow of processes in the intent match search engine for handling one search query.

The block (500) provides a search query interface which a user can enter a search query. The search query interface can be a graphics based interface such as the one in FIG. 1. The search query interface (500) is the user interface that the intent match search engine provides to its users. To use the intent match search engine, a user enters his search query in the input box of the search query interface, and then clicks on the “Search” button or simply presses the “enter” key on his keyboard.

The search query interface can have an “Advanced Options” button. If a user clicks on that button, then, the intent match search engine will show some advanced options that the user can choose, such as that the user can exclude web pages that contain certain words.

The search query interface can also be a sound based interface, a graphics and sound based interface, or another type of interfaces. For a sound based interface, a sound based input device may need to be added if there are not already sound based input devices such as a microphone.

The blocks that the intent match search engine will go through after it receives a search query from the search query interface are described below.

After the intent match search engine receives a search query, the intent match search engine proceeds to (510) to check whether there are likely errors in the search query, such as typos.

At (510), if the intent match search engine determines that there are no input errors in the search query, then the intent match search engine proceeds to (520) to check whether the user's search query is an exact match query.

At (510), if the intent match search engine determines that there are likely input errors in the search query, then the intent match search engine proceeds to (511) to try to correct the input errors. At (511), the intent match search engine makes corrections to the original search query and presents the corrected search query to the user for his confirmation.

If the user confirms the corrections, then the intent match search engine takes modified search query at (512) and proceeds to (520); and if the user denies the corrections, then the intent match search engine takes the original search query at (513) and proceeds to (520).

At this point, the intent match search engine has proceeded to (520) through some path. At (520), the intent match search engine will check whether the user's search query is an exact match query.

When a user performs web search using a query based search engine, sometimes, the user may want to search the World Wide Web to get the web pages that contain the exact search query. In this case, the syntax can be including the search query in double quotes “and”. For example, for the search example <contact information of Jianwei Dian>, if the user wants to find the web pages that contain the exact phrase “contact information of Jianwei Dian”, the user can use the search query <“contact information of Jianwei Dian”>.

At (520), if the intent match search engine finds that the search query is not an exact match query, then it proceeds to (530) to perform syntax and semantics analysis of the search query and generate an intent match criterion that will be used to match the web pages. Here and hereafter, the term “syntax” refers to the arrangement of words and phrases to create meaningful sentences, and the term “semantics” refers to the branch of linguistics and logic concerned with meaning. There are several forms of semantics. For examples, formal semantics studies the logical aspects of meaning, such as sense, reference, implication and logical form; lexical semantics studies word meanings and word relations; and conceptual semantics studies the cognitive structure of meaning.

The search query <contact information of Jianwei Dian> will be used as an example for describing how to generate an intent match criterion. In the search example <contact information of Jianwei Dian>, the user's intent is to find contact information about Jianwei Dian. The “contact information” is an essential part and “Jianwei Dian” is the other essential part of the search query.

The match to “contact information” can be “contact information”, “telephone number”, “telephone”, “phone number”, “phone”, “cell phone number”, “cell phone”, a digital phone number such as “123-456-7890”, “email address”, “email”, an actual email address such as “abc@xyz.com”, “mailing address”, “address”, an actual address such as “123 Abc Road, Xyz, TX 75025”, etc. If MATCH1 is used to represent the match for “contact information”, then MATCH1 can be any of the things mentioned above, such as an actual address.

The match to “Jianwei Dian” can be “Jianwei Dian”, “Dian, Jianwei”, “First name: Jianwei; Last Name: Dian”, etc. (Please note here that cases of words and punctuation symbols such as “,” are ignored in the matching.) If MATCH2 is used to to represent the match for “Jianwei Dian”, then MATCH2 can be any of “Jianwei Dian”, “Dian, Jianwei”, “First name: Jianwei; Last Name: Dian”, etc.

Then, the search intent is translated into two matching items MATCH1 and MATCH2. The matching items MATCH1 and MATCH2 will be used to decide whether or not a web page is a matched web page. The criterion is whether the web page contains both MATCH1 and MATCH2.

It should be noted that a matching item, such as the MATCH1 mentioned above, doesn't just contain one phrase, such as “contact information”, MATCH1 is actually a set of phrases:

MATCH1={“contact information”, “telephone number”, “telephone”, “phone number”, “phone”, “cell phone number”, “cell phone”, a digital phone number such as “123-456-7890”, “email address”, “email”, an actual email address such as “abc@xyz.com”, “mailing address”, “address”, an actual address such as “123 Abc Road, Xyz, TX 75025”, . . . }.

Each of the phrases is called a member of MATCH1. Any web page that contains a member of MATCH1 is said to contain a match to MATCH1, or simply is said to contain MATCH1.

Generally, assume that the user's search intent is translated to matching items MATCH₁, MATCH₂, . . . , MATCHₘ, then, the web pages containing MATCH₁, MATCH₂, . . . , MATCHₘ (with any order in which the matching items appear) would probably be of interest to the user. The collection (MATCH₁, MATCH₂, . . . , MATCHₘ) is called an intent match criterion.

If the intent match search engine is successful in performing syntax and semantics analysis of the search query and translating the user's search intent to an intent match criterion (MATCH₁, MATCH₂, . . . , MATCHₘ), the intent match search engine will generate the intent match criterion (MATCH₁, MATCH₂, . . . , MATCHₘ) and associate a match status of “intent match” to the intent match criterion (MATCH₁, MATCH₂, . . . , MATCHₘ). Generating an intent match criterion is one of the major differences between Google and the intent match search engine of the present invention, since Google is basically a word match search engine.

If the intent match search engine is not successful in performing syntax and semantics analysis of the search query or is not successful in translating the user's search intent to an intent match criterion, the intent match search engine will simply take each word (ignoring words like “the”, “a”, “an”, “to”, etc.) in the search query as a matching item and generate a match criterion (MATCH₁, MATCH₂, . . . , MATCHₘ). It also associates a match status of “word match” with the match criterion (MATCH₁, MATCH₂, . . . , MATCHₘ). For simplicity, this match criterion is also called an “intent match criterion”, even though it has a status of “word match”. In the “word match” criterion (MATCH₁, MATCH₂, . . . , MATCHₘ), each matching item MATCH1 (i=1, 2, . . . , m) contains only one single word. This type of match (that is, word match) is the same type of match that currently popular query based search engines, such as Google, are doing.

After generating the intent match criterion (MATCH₁, MATCH₂, . . . , MATCHₘ) at (530), the intent match search engine proceeds to (540) to try to identify all matched web pages. Here, a “matched web page” is a web page that matches the user's search intent expressed in the search query. What exactly that means and how to identify matched web pages are described below.

Before describing what a matched web page is and how the matched web pages are identified, an analogy is described below to help understanding the matching process, or, the process to identify the matched web pages.

Imagine how a user searches a professional journal to find the information he wants. First, he would look at the titles of the articles. After finding an article that, judged from its title, seems to likely contain what he is looking for, he would look into the abstract of the article. Finally, judged from the title and abstract, if the article seems to likely contain what he is looking for, he would briefly look through (scan) some texts of the article to see whether he can find what he is looking for.

The intent match search engine uses a similar approach to identify matched web pages. In the preferred embodiment, the title of a web page will not be considered in identifying a matched web page. There reason for ignoring the title is that some web developers use other web pages' source files (typically HTML files) as templates, or use some type of standard templates, but forget to change the titles of the web pages. (Of course, the implementer of the intent match search engine can choose to take the titles of the web pages into consideration in identifying matched web pages.)

When checking a document to decide whether it's a matched document, the intent match search engine not only checks into the document itself, but also checks into the abstracts of the document in order to find matches.

For the intent match criterion (MATCH₁, MATCH₂, . . . , MATCHₘ) and for an abstract of the web page X, if the abstract contains all the matching items MATCH₁, MATCH₂, . . . , MATCHₘ, then, the abstract is said to have a match. If an abstract has a match, then the abstract is called a matched abstract.

If an abstract only contains some, but not all of the matching items MATCH₁, MATCH₂, . . . , MATCHₘ, then the abstract doesn't have a match and is not a matched abstract.

The situation is the same for the web page X itself: if the web page contains all the matching items MATCH₁, MATCH₂, . . . , MATCHₘ, the web page is said to have a match. If the web page only contains some, but not all, of the matching items MATCH₁, MATCH₂, . . . , MATCHₘ, then web page doesn't have a match.

Here, the order in which the matching items MATCH₁, MATCH₂, . . . , MATCHₘ occur in the abstract or on the web page doesn't matter. For examples, MATCH₁, MATCH₂, MATCH₃, . . . , MATCHₘ is a match, MATCH₂, MATCH₁, MATCH₃, . . , MATCHₘ is a match, MATCHₘ, MATCH₃, MATCH₁, . . . , MATCH₂ is a match, and MATCH₁, MATCH₃, MATCHₘ, . . . , MATCH₂ is also a match.

Also, for there to be a match MATCH₁, MATCH₂, . . . , MATCHₘ in an abstract, all of the matching items MATCH₁, MATCH₂, . . . , MATCHₘ need to appear in that particular abstract. For there to be a match MATCH₁, MATCH₂, . . . , MATCHₘ on the web page X itself, all of the matching items MATCH₁, MATCH₂, . . . , MATCHₘ need to appear on the web page. If some (but not all) of the matching items MATCH₁, MATCH₂, . . . , MATCHₘ occur in an abstract, but the rest of MATCH₁, MATCH₂, . . . , MATCHₘ occur on the web page, then MATCH₁, MATCH₂, . . . , MATCHₘ is not a match. If some (but not all) of MATCH₁, MATCH₂, . . . , MATCHₘ occur in one abstract, but the rest of MATCH₁, MATCH₂, . . . , MATCHₘ occur in a different abstract, then MATCH₁, MATCH₂, . . . , MATCHₘ is not a match either. In what follows, {MATCH₁, MATCH₂, . . . , MATCHₘ} will be used to represent a match with respect to the match criterion (MATCH₁, MATCH₂, . . . , MATCHₘ).

A web page is said to be a matched web page if and only if either there is a match in an abstract or there is a match on the web page itself.

At (540), the intent match search engine checks every web page to identify all the matched web pages. In other words, for every web page, the intent match search engine will try to identify all the matches in the abstracts of the web page and on the web page itself.

For each match {MATCH₁, MATCH₂, . . . , MATCHₘ} occurring either in an abstract or on the web page itself, a separation degree (SeparationDegree) will be computed and associated with that particular match. The SeparationDegree is computed in the following way: First, for any two adjacent MATCH'es, compute the number of words between the two adjacent MATCH'es and take that number as the distance between the two adjacent MATCH'es. Then sum up all the distances and take the sum as the SeparationDegree of that particular match. The smallest possible SeparationDegree is 0, meaning that the matching items MATCH₁, MATCH₂, . . . , MATCHₘ are immediately together one after another, but note that they may be in a different order.

For a matched abstract, if MATCH₁, MATCH₂, . . . , MATCHₘ all occur only once, then that match {MATCH₁, MATCH₂, . . . , MATCHₘ} is taken as the match in that particular abstract, and its SeparationDegree is taken as the separation degree of match in that particular abstract. If some or all of MATCH₁, MATCH₂, . . . , MATCHₘ occur multiple times in the abstract, then all the possible combinations of MATCH₁, MATCH₂, . . . , MATCHₘ that can form a match {MATCH₁, MATCH₂, . . . , MATCHₘ} need to be considered, and their SeparationDegree's need to be computed. Then, the match {MATCH₁, MATCH₂, . . . , MATCHₘ} with the least SeparationDegree is taken as the match in that particular abstract, and its SeparationDegree is taken as the separation degree of match in that particular abstract. All the other matches are then ignored.

If two or more matches have the least SeparationDegree, then, assuming the order of the matching items occurring in the search query is MATCH₁, MATCH₂, . . . , MATCHₘ, then the match {MATCHᵢ₁, MATCHᵢ₂, . . . , MATCHᵢₘ} for which the permutation (i1, i2, . . . , im) is closest to the initial order (1, 2, . . . , m) is taken as the match in that particular abstract, and its SeparationDegree is taken as the separation degree of match in that particular abstract. If two or more such least SeparationDegree matches are equally closest to the initial order (1, 2, . . . , m), the match that has the earliest beginning is taken as the match in that particular abstract, and its SeparationDegree is taken as the separation degree of match in that particular abstract. (Here, the “beginning” of a match {MATCH₁, MATCH₂, . . . , MATCHₘ} is the matching item in MATCH₁, MATCH₂, . . . , MATCHₘ that comes first in that particular abstract.) If there are still two or more abstracts after applying the above filtering criteria, then any of those matches can be taken as the match in that particular abstract, and its SeparationDegree is taken as the separation degree of match in that particular abstract.

After the match and separation degree of the match in a particular abstract are identified, then they will be associated with the matched abstract, and all the other matches in that particular abstract are then ignored.

In summary, for each matched abstract, only one match and its SeparationDegree will be associated with the abstract as the match in that particular abstract and the separation degree of match in that particular abstract.

The process to identify the match and compute separation degree of match for the web page itself is the same as that for handling an abstract of the web page. Thus, even there may be multiple matches on the web page itself, only one match and its SeparationDegree will be associated with the web page as the match on the web page and the separation degree of the match on the web page.

For each matched web page, the following items will be associated with the web page: 1) if there are matched abstracts, all the matched abstracts; and 2) if there are matches on the web page itself, the match on the web page and the separation degree of match. (Note that, for each matched abstract, the match and separation degree of match in that particular abstract are associated with the matched abstract.)

As already stated, both matches in abstracts and matches on the web page itself qualify the web page to be a matched web page. However, as will be described below, locations of the matches have impact on the relevance rankings (with respect to the user's search intent) of matched web pages.

At (540), if the intent match search engine doesn't find any matched web pages, then it proceeds to (541) to check the status of the match: Whether it's an intent match or it's a word match.

At (541), if the intent match search engine finds out that the match is word match, then the intent match search engine notifies the user that no web pages can be found for his search query, and then returns to the search query interface (500) for the user to enter a new search query.

At (541), if the intent match search engine finds out that the match is an intent match, then the intent match search engine proceeds to (542) to take each single word in the search query as a matching item MATCHᵢ(i=1, 2, . . . , m), generate an intent match criterion (MATCH₁, MATCH₂, . . . , MATCHₘ), associate the match criterion with a match status of “word match”, and then proceeds to (540).

It's obvious from the flow of processes that word match is the last resort that the intent match search engine will do if it fails at intent match. Also, the flow of (540)→(541)→(542)→(540) can only happen once, since the second time the status of the match will definitely be word match, and thus, the intent match search engine returns to the search query interface (500) from (541).

At (540), if the intent match search engine finds matched web pages, then it will create a list of matched web pages and proceed to (550) to compute normalized relevance degrees (nWPRelevD) of all the matched web pages.

At this point, either the intent match search engine has returned to the search query interface (500) for the user to enter a new search query, or the intent match search engine has proceeded to (550) to compute normalized relevance degrees of all the identified matched web pages.

The computing of normalized relevance degrees of all the matched web pages are done in two steps: First, for each matched web page, a relevance degree (WPRelevD) will be computed, and then, based on the relevance degrees of all the matched web pages, a normalized relevance degree (nWPRelevD) will be computed for each matched web page.

Below is how to compute the relevance degree (WPRelevD) of a matched web page.

First, compute a relevance degree of each match. The relevance degree of a particular match depends on two measurements of that match: location match degree and intent match degree. The location match degree (LMD) depends on where the match occurs, and the intent match degree (IMD) depends on how well the match matches the user's search intent.

To compute the location match degree of a match, if the match occurs in an abstract, then the location match degree can be

LMD=nARD*0.75,

where nARD is the normalized abstract reliability degree of that particular abstract; and, if the match occurs on the web page itself, then the location match degree can be

LMD=nWPReliaD*0.5,

where nWPReliaD is the normalized reliability degree of the web page.

Here, the numbers 0.75 and 0.5 are the weights assigned to abstracts and the web page, respectively. It reflects the valuation that a match in an abstract is taken as indicating that the information on the web page more likely contains what the user is looking for.

Of course, computational formula for the location match degree can be different.

The intent match degree of a match is computed as

IMD=1/(1+SeparationDegree*epsilon),

where SeparationDegree is the separation degree of that particular match, and “epsilon” is a small positive number, such as epsilon=0.001. The number epsilon is a pre-defined number, and it doesn't depend on any user searches or on any matches. The currently preferred value of epsilon is 0.001.

After the location match degree and intent match degree of a particular match are obtained, the relevance degree of that particular match (MRD) can be computed as

MRD=W1*LMD+W2*IMD,

where W1 and W2 are two non-negative numbers and W1+W2=1. W1 and W2 are the weights assigned to location match degree and intent match degree, respectively. The weights W1 and W2 are pre-defined numbers, and they don't depend on any web pages or any searches. For example, W1 and W2 can be set as W1=0.5 and W2=0.5, or W1=0.382 and W2=0.618, or W1=0.618 and W2=0.382, or something else. Experiments can be performed to see what values of W1 and W2 can yield best search results. The currently preferred values of W1 and W2 are W1=0.382 and W2=0.618.

Of course, different formulas can be devised to compute MRD. MRD typically should be a function of where the match occurs and how well the match matches the user's search intent.

If there are matched abstracts identified at (540) for a web page, then, at (550), the intent match search engine associates with that matched web page an abstract called Most Relevant Matched Abstract. The Most Relevant Matched Abstract is the matched abstract whose match has the highest relevance degree (MRD). If there are two or more such abstracts whose matches have the same highest relevance degree, then, the Most Relevant Matched Abstract is the shortest abstract (the abstract that contains the least words). If there are two or more such shortest abstracts, then, the Most Relevant Matched Abstract is the one that has the least characters. If there are two or more such abstracts with the least characters, then the Most Relevant Matched Abstract can be any of those abstracts.

After relevance degrees (MRD) of all the matches for a web page (either in abstracts for the web page or on the web page itself) are obtained, the largest MRD is taken as the relevance degree of that matched web page (WPRelevD).

After the relevance degrees of all the matched web pages are obtained, the normalized relevance degrees (nWPRelevD) of all the matched web pages can be computed.

Suppose there are altogether m matched web pages WP₁, WP₂, . . . , WPₘ, and their corresponding relevance degrees are WPRelevD₁, WPRelevD₂, . . . , WPRelevDₘ. Then, the normalized relevance degrees of the matched web pages WP₁, WP₂, . . . , WPₘ can be computed as

nWPRelevD₁=WPRelevD₁/max(WPRelevD₁, WPRelevD₂, . . . , WPRelevDₘ)

nWPRelevD₂=WPRelevD₂/max(WPRelevD₁, WPRelevD₂, . . . , WPRelevDₘ)

. . .

nWPRelevDₘ=WPRelevDₘ/max(WPRelevD₁, WPRelevD₂, . . . , WPRelevDₘ)

The normalized relevance degree of a matched web page is meant to measure how well the web page matches the user's search intent. In other words, the larger the normalized relevance degree that a matched web page has, the more probable that the web page contains what the user is looking for. The largest normalized relevance degree is always 1. To distinguish, the relevance degrees before normalization (WPRelevD) are called non-normalized relevance degrees.

After the normalized relevance degrees of all the matched web pages are obtained at (550), the intent match search engine proceeds to (560) to compute the overall ranks of all the matched web pages.

The overall ranks of all the matched web pages will decide which web page to present to the user first, which to present second, which to present third, and so on and so forth. The overall rank of a matched web page depends on the normalized relevance degree (nWPRelevD) of that web page, the normalized reliability degree (nWPReliaD) of that web page, and if available, the historical degree (nWPHistoD) of that web page.

There are two cases in computing the overall ranks of the matched web pages, and the details are described below.

Case 1: The user is in the User Store and the search query is in the user's Search Query Store. (See “B-3: Compute Historical Degrees after Each Search” for details of User Store, Search Query Store and historical degrees.)

In this case, a Visited Web Pages List is associated with the search query in user's Search Query Store, and a historical degree (nWPHistoD) is associated with each web page in the Visited Web Pages List.

If the matched web page is in the Visited Web Pages List associated with the search query in user's Search Query Store, then the overall rank of the matched web page is:

WPOverallRank=RW1*nWPRelevD+RW2*nWPReliaD+RW3*nWPHistoD.

If the matched web page is not in the Visited Web Pages List associated with the search query in user's Search Query Store, then the overall rank of the matched web page is:

WPOverallRank=RW1*nWPRelevD+RW2*nWPReliaD.

Here, nWPRelevD is the normalized relevance degree of that particular web page computed at (550), nWPReliaD is the normalized reliability degree of that particular web page computed in “B-1: Compute Reliability Degrees of the Web Pages”, and if available, nWPHistoD is the historical degree of that particular web page computed in “B-3: Compute Historical Degrees after Each Search”.

Here, RW1, RW2 and RW3 are the weights assigned to the normalized relevance degrees, the normalized reliability degrees and the historical degrees, respectively. Furthermore, RW1, RW2 and RW3 are non-negative numbers, and RW1+RW2+RW3=1. For example, RW1, RW2 and RW3 can be set as RW1=0.4, RW2=0.3 and RW3=0.3. They can be set as RW1=0.5, RW2=0.25 and RW3=0.25. They can also be set as something else. Currently, it is preferred to set them as RW1=0.4, RW2=0.3 and RW3=0.3.

The larger the value of a weight is, the larger the importance of the corresponding factor is in the computing of the overall rank. For an example, the setting of RW1=0.4, RW2=0.3 and RW3=0.3 means that more importance is given to the relevance (with respect to what the user is looking for) of the web pages. For another example, if users'search history is not going to be considered in the ranking of the matched web pages, then set RW3=0.

The values of RW1, RW2 and RW3 are predefined, and they are independent of any users or their web searches. Also, even though it is currently preferred to set them as RW1=0.4, RW2=0.3 and RW3=0.3, experiments should be done with different sets of values to find out what combinations of values yield the best search results.

Case 2: The user is not in the User Store or the search query is not in the user's Search Query Store.

In this case, the overall rank of a matched web page is:

WPOverallRank=SW1*nWPRelevD+SW2*nWPReliaD.

Here, nWPRelevD is the normalized relevance degree of that particular web page computed at (550) and nWPReliaD is the normalized reliability degree of that particular web page computed in “B-1: Compute Reliability Degrees of the Web Pages”.

Here, SW1 and SW2 are the weights assigned to the normalized relevance degrees and the normalized reliability degrees, respectively. Furthermore, SW1 and SW2 are non-negative numbers, and SW1+SW2=1. For example, SW1 and SW2 can be set as SW1=0.618 and SW2=0.382, SW1=0.5 and SW2=0.5, or something else. The currently preferred values of SW1 and SW2 are SW1=0.618 and SW2=0.382.

In this case, there are no search histories of the search query for the user. Thus, there is no historical factor in the computing of the overall rank.

After computing the overall ranks of all the matched web pages at (560), the intent match search engine proceeds to (570) to set the order in which to present the matched web pages to the user. That is, the intent match search engine will decide which web page to present to the user first, which second, which third, and so on and so forth at (570).

The order in which to present the matched web pages is important, since it's important to present to the user first the matched web pages that most likely contain what the user is looking for. A better order means that the user needs to actually navigate through fewer web pages before he finds what he is looking for. This will save the user's time.

It's currently preferred to present the matched web pages according to their overall ranks. The order will be set as the following: the highest ranked matched web page is the first, the second highest ranked matched web page is the second, the third highest ranked matched web page is the third, and so on and so forth.

If two or more matched web pages have the same overall rank, set their order according to their normalized relevance degrees: the matched web page with the highest normalized relevance degree comes the first, the matched web page with the second highest normalized relevance degree comes the second, the matched web page with the third highest normalized relevance degree comes the third, and so on and so forth.

If two or more matched web pages have both the same overall rank and the same normalized relevance degree, set their order according to their normalized reliability degrees: the matched web page with the highest normalized reliability degree comes the first, the matched web page with the second highest reliability degree comes the second, the matched web page with the third highest normalized reliability degree comes the third, and so on and so forth.

If two or more matched web pages have the same overall rank, the same normalized relevance degree and the same normalized reliability degree, then either they both not have a historical degree or they both have the same historical degree. In this case, set their order according to whether or not they have matched abstracts: The group of matched web pages that have matched abstracts (Matched-abstract Group) comes first, and the group of matched web pages that don't have matched abstracts (No-matched-abstract Group) comes second.

Within the No-matched-abstract Group mentioned above, set the order of the matched web pages according to the separation degrees of matches on the matched web pages: The smaller the separation degree, the earlier the matched web page. (Note that, for the matched web pages in this group, there are no matched abstracts. Thus, there must be matches on the web pages themselves.) If two or more matched web pages have the same separation degree of match, then set them in any order.

Within the Matched-abstract Group mentioned above, set the order of the matched web pages according to the relevance degrees of the matches (MRD) in the Most Relevant Matched Abstracts that were associated with the web pages at (550): The higher the relevance degree, the earlier the matched web page. If two or more Most Relevant Matched Abstracts have the same relevance degree, then set their order according to whether or not there are matches on the web pages themselves: The group of matched web pages that have matches on the web pages themselves (Match-on-web-page Group) comes first, and the group of matched web pages that don't have matches on the web pages themselves (No-match-on-web-page Group) comes second.

Within the No-match-on-web-page Group mentioned above, set the matched web pages in any order.

Within the Match-on-web-page Group mentioned above, set the order of the matched web pages according to the separation degrees of matches on the matched web pages: The smaller the separation degree, the earlier the matched web page. If two or more matched web pages have the same separation degree of match on the web pages, then set them in any order.

After set the order in which to present the matched web pages at (570), the intent match search engine proceeds to (580) to present the matched web pages to the user.

The intent match search engine will present the matched web pages in the order set at (570). It's already mentioned above that the order in which to present the matched web pages is important. At the same time, for each matched web page, what to present about the web page is also important. As already mentioned in “C. Objects and Advantages of the Invention” of the “BACKGROUND OF THE INVENTION”, for a matched web page, appropriately presented items about that web page make it more likely that, without taking time to actually scan through the web page, a user can tell whether that web page contains what he is looking for.

For a matched web page, the intent match search engine will display to the user the following items, in the order, related to the web page:

1) The title of the web page as a hyperlink to the original web page. That is, if the user clicks on the link, he will be redirected to the original web page being presented. This is the same as what is being done in currently popular query based search engines, such as Google.

2) If there are matched abstracts, then display the Most Relevant Matched Abstract that was associated with the web page at (550), with the match in the abstract highlighted.

If there are no matched abstracts but there are abstracts, then display the most reliable abstract that was associated with the web page in “B-2: Abstract the Web Pages”.

Usually, an abstract is short so that all of the contents of the abstract may be displayed. However, in case the abstract to be displayed is too long to fit into the space allocated, then, in case it's the Most Relevant Matched Abstract, display the match in that abstract with some surrounding texts, and in case it's the most reliable abstract, display as much as possible text from the beginning of the abstract.

If there are no abstracts for the web page, then simply skip this item.

With respect to what to present to the user for a matched web page, displaying an abstract for a matched web page is one the superiorities that the intent match search engine has over the currently popular searches, such as Google. An abstract gives a summary of what the web page is mainly about. An abstract tells at least some main points (if not all the main points) on the web page.

Judging from the displayed abstracts, without the need to actually navigate through the web pages, the user is more likely able to tell which web pages likely contain what he is looking for. (This is just like that the abstracts of articles in a professional journal help a reader to judge which articles likely contain what he is looking for without the need for the reader to actually read through or scan through the articles.) Then, after the user identifies the web pages that most likely contain what he is looking for, he can look into the web pages to try to find what he is looking for. If one or more abstracts already contain what the user is looking for, the user even doesn't need to look into any of the presented web pages.

3) If the web page itself has a match, then display the match with some surrounding texts, with the match highlighted.

If there are no matches on the web page, then don't display any actual content on the web page. Note in this case, there must be matched abstracts of the web page. Thus, the Most Relevant Matched Abstract must have been displayed in item 2).

The above are the items that the intent match search engine displays for a matched web page. Displaying a link to the matched document, an abstract of the matched document if there are abstracts of the matched document, and a match in the matched document if there are matches in the matched document forms an independent method for presenting a matched document to a user of a query based search engine that searches a database of linked documents.

The items about a matched web page that the intent match search engine displays make it more likely that a user can tell whether that web page contains what he is looking for without him taking time to actually navigate through the web page. Of course, even the user knows that a web page contains what he is looking for, the user may still need to eventually visit that web page to find the information that he is looking for. However, in some cases, the items displayed by the intent match search engine about a matched web page may already contain the information that the user is looking for, and in these cases, the user even doesn't need to visit any matched web pages.

The above described what the intent match search engine will display for one matched web page. For presenting all the matched web pages, the intent match search engine can use the same method used by currently popular query based search engines, such as Google. To be specific, the intent match search engine will present the matched web pages in multiple web browser pages with page numbers at the bottom. If a user clicks on a particular page number, all the matched web pages on that web browser page will be presented to the user. (Here, a “web browser page” is a single web page designed to be displayed by the web browser. A user can scroll up and down within that single web page to view all the matched web pages contained on that single web page without going to another web page.)

The intent match search engine can choose to display a certain number, such as 10, of web browser page numbers with navigation buttons that the user can use to get previous 10 web browser page numbers or afterward 10 web browser page numbers, if there are so many web browser pages.

Also, besides displaying matched web pages, the intent match search engine can also display its search query interface (500) at the top, at the bottom, or at both the top and the bottom of the web browser page, so that the user can do a new search at any time during he looks at the displayed matched web pages.

By presenting all the matched web pages at (580), the intent match search engine completes handling one search query under the condition that the search is determined as not an exact match search request at (520).

At (520), if the intent match search engine finds that the search is an exact match search request, which means the user is requesting an exact match of the query, then the intent match search engine proceeds to (521) to try to find the web pages that contain the exact search query. For example, if the search query is <“contact information of Jianwei Dian”>, then the intent match search engine will try to find the web pages that contain the exact phrase “contact information of Jianwei Dian”.

At (521), for checking whether a web page X is an exact matched web page, the intent match search engine doesn't look into the abstracts of that web page at all. The reason is that the user's search intent is to find web pages that contain the exact query. However, the abstracts of the web page X are summaries that other web pages make about the web page X. An exact match of the query in an abstract of the web page X doesn't mean that there will be an exact match of the query on the web page X itself.

At (521), for a web page X, if the intent match search engine find exact matches on the web page, then the web page X will be called an exact matched web page.

Not like the step (540) in which the intent match search engine computes a separation degree for each match, at step (521), for exact matches, the intent match search engine doesn't compute a separation degree for a match, since all the exact matches have a separation degree of 0.

If a web page is an exact matched web page, then the intent match search engine takes the very first exact match on the web page as the exact match on the web page, and ignores all other exact matches. The exact match on the web page will be associated with the exact matched web page.

At (521), if the intent match search engine doesn't find any web pages that contain exact matches to the search query, then the intent match search engine notifies the user that no web pages can be found for his search query, and then returns to the search query interface (500) for the user to enter a new search query.

At (521), if the intent match search engine does find exact matched web pages, then the intent match search engine will create a list of the exact matched web pages and proceed to (522) to compute the overall ranks of all the exact matched web pages. The overall ranks of all the exact matched web pages will decide which web page to present to the user first, which to present second, which to present third, and so on and so forth. The overall rank of an exact matched web page depends on its normalized reliability degree (nWPReliaD), and if available, its historical degree (nWPHistoD).

There are two cases in computing the overall ranks of the exact matched web pages, and the details are described below.

Case 1: The user is in the User Store and the exact match search query is in the user's Search Query Store. (See “B-3: Compute Historical Degrees after Each Search” for details of the data structure User Store and historical degrees.)

Here, it should be noted that, even an exact match search query and a non-exact match search query have the same contents besides the double quotes “and”, they are two different search queries in the Search Query Store, if they are all in the Search Query Store. For an example, the exact match search query <“contact information of Jianwei Dian”> and the non-exact match search query <contact information of Jianwei Dian> are two different search queries in the Search Query Store, if they are all in the Search Query Store.

In Case 1, a Visited Web Pages List is associated with the search query in user's Search Query Store, and a historical degree (nWPHistoD) is associated with each web page in the Visited Web Pages List.

If an exact matched web page is in the Visited Web Pages List associated with the search query in user's Search Query Store, then the overall rank of the exact matched web page is:

WPOverallRank=TW1*nWPReliaD+TW2*nWPHistoD.

If an exact matched web page is not in the Visited Web Pages List associated with the search query in user's Search Query Store, then the overall rank of the exact matched web page is:

WPOverallRank=TW1*nWPReliaD.

Here, nWPReliaD is the normalized reliability degree of that particular web page computed in “B-1: Compute Reliability Degrees of the Web Pages”, and if available, nWPHistoD is the historical degree of that particular web page computed in “B-3: Compute Historical Degrees after Each Search”.

Here, TW1 and TW2 are the weights assigned to the normalized reliability degrees and the historical degrees, respectively. Furthermore, TW1 and TW2 are non-negative numbers, and TW1+TW2=1. For example, TW1 and TW2 can be set as TW1=0.5 and TW2=0.5. They can also be set as TW1=0.618 and TW2=0.382, or something else. Currently, it is preferred to set them as TW1=0.5 and TW2=0.5.

The larger the value of a weight is, the larger the importance of the corresponding factor is in the computing of the overall ranks. For an example, the setting of TW1=0.5 and TW2=0.5 means that equal importance is given to the reliability degrees and historical degrees. For another example, if users' search history is not going to be considered in the ranking of the exact matched web pages, then set TW1=1 and TW2=0.

The values of TW1 and TW2 are predefined, and they are independent of any users or their web searches. Also, even though it is currently preferred to set them as TW1=0.5 and TW2=0.5, experiments should be done with different values of TW1 and TW2 to find out what combinations of values yield best search results.

Case 2: The user is not in the User Store or the exact match search query is not in the user's Search Query Store.

In this case, the overall rank of an exact matched web page is:

WPOverallRank=nWPReliaD.

In this case, there are no search histories of the exact match search query for the user. The overall rank of an exact matched web page is simply its normalized reliability degree.

The step (522) is different from the step (560). In the computing of overall ranks at (522), there are no relevance degrees in the computations. The reason is that the location and separation degree of the exact match on any exact matched web pages are the same as those on any other exact matched web pages. It means that all the exact matched web pages have the same relevance degree.

After computing the overall ranks of all the exact matched web pages at (522), the intent match search engine proceeds to (523) to set the order in which to present the exact matched web pages to the user. That is, the intent match search engine will decide which web page to present to the user first, which second, which third, and so on and so forth.

The order of the exact matched web pages is set according to the overall ranks of the exact matched web pages. The order will be set as the following: the highest ranked exact matched web page is the first, the second highest ranked exact matched web page is the second, the third highest ranked exact matched web page is the third, and so on and so forth.

If two or more exact matched web pages have the same overall rank, set their order according to whether or not they have associated historical degrees: The group of exact matched web pages that have historical degrees comes first, and the group of exact matched web pages that don't have historical degrees comes second. Further more, within the same group, set the exact matched web pages in any order among themselves.

After setting the order in which to present the exact matched web pages at (523), the intent match search engine proceeds to (524) to present the exact matched web pages to the user.

The intent match search engine will present the exact matched web pages according to the order set at (523). For an exact matched web page, what items to display and how to display them are the same as those already explained in the descriptions for the step (580), except the criterion for choosing the abstract to display: If the exact matched web page has abstracts, then simply display the most reliable abstract that was associated with the web page in “B-2: Abstract the Web Pages”, since there is no such a notion of matched abstract in the exact match case. For details of displaying the exact matched web pages, refer to the descriptions for the step (580).

By presenting all the exact matched web pages at (524), the intent match search engine completes handling of one search query under the condition that the search is determined as an exact match search request at (520).

Also, after a user completes his search, which means that he visited some matched web pages and found what he was looking for, or simply quitted visiting the matched web pages, then the intent match search engine will compute the historical degrees of all the web pages (if any) that the user visited and update the User Store. See “B-3: Compute Historical Degrees after Each Search” for details about how that is done.

In the steps of the detailed flow of the processes for handling one search query, there are various mathematical formulas and various parameters in the mathematical formulas. Even though the preferred values were given for those parameters, experiments should be done with different values of the parameters to see what combinations of the values of the parameters would generate best search results based on historical search data.

Historical search data can be used in experiments with the various parameters. In using a user's historical search data, with respect to a particular search (or, search query), the last web page that the user visited can be deemed as the web page that contains what the user was looking for. (Of course, sometimes, that may not be the case, since the user might simply stop navigating through the presented web pages at some point even the user didn't find what he is looking for. However, that case should be exception rather than usual.)

In experiments with various parameters using historical search data, the goal can be: identify the values of the parameters that can generate best search results for the chosen sample of historical search data. The criterion for “best search results” can be: for all the selected users and search queries, the number of occurrences is the largest for the case that the last visited web page is the highest ranked web page. The criterion for “best search results” can be other appropriate measures, too.

### C. Variations of the Preferred Embodiment

It should be understood that the above descriptions of the preferred embodiment should not be construed as limiting the scope of the present invention. The descriptions should be appreciated by those skilled in the art that the conception and the specific embodiment disclosed may be readily utilized as a basis for modifying or designing other structures (including but not limited to various changes, substitutions and alterations) for carrying out the same or similar purposes of the present invention, and that such equivalent constructions do not depart from the spirit and scope of the present invention.

Below are some examples of possible modifications/variations. Again, the following examples should not be construed as limiting the scope of the present invention.

(1) In “B-1: Compute Reliability Degrees of-the Web Pages,” normalized reliability degrees were computed and used as reliability degrees of the web pages (that is, the documents). Even though it's preferred to normalize the non-normalized reliability degrees to obtain normalized reliability degrees, the implementer of the intent match search engine can choose to take the non-normalized reliability degrees as reliability degrees. In “A. General Description” and in the claims, the term “reliability degree” of a document should be interpreted in the sense that it can be the non-normalized reliability degree and it also can be the normalized reliability degree, depending on how the intent match search engine is implemented. The “reliability degree” of a document can also be something else if the implementer of the intent match search engine chooses to use a different method to compute the “reliability degree” of a document.

(2) In “B-2: Abstract the Web Pages,” nARDs were computed and used as reliability degrees of the abstracts of a web page. Even though it's preferred to normalize ARD to obtain nARD, the implementer of the intent match search engine can choose to take ARDs as reliability degrees of abstracts. In the claims, the term “reliability degree” of an abstract should be interpreted in the sense that it can be the ARD and it also can be the nARD, depending on how the intent match search engine is implemented. The “reliability degree” can also be something else if the implementer of the intent match search engine chooses to use a different method to compute the “reliability degree” of an abstract.

(3) In “B-4: Handling One Search Query”, normalized relevance degrees (nWPRelevD) were computed and used as relevance degrees of the web pages (that is, the documents). Even though it's preferred to normalize the non-normalized relevance degrees (WPRelevD) to obtain normalized relevance degrees (nWPRelevD), the implementer of the intent match search engine can choose to take the non-normalized relevance degrees as relevance degrees. In “A. General Description” and in the claims, the term “relevance degree” of a document should be interpreted in the sense that it can be the non-normalized relevance degree and it also can be the normalized relevance degree, depending on how the intent match search engine is implemented. The “relevance degree” of a document can also be something else if the implementer of the intent match search engine chooses to use a different method to compute the “relevance degree” of a document.

(4) In the detailed descriptions of the invention, there are various mathematical formulas and various parameters in the mathematical formulas. Those formulas and the values of the parameters are the currently preferred formulas and values. Alternative formulas can be devised which don't depart from the spirit and scope of the formulas in the descriptions. Experiments can be done with different values of the various parameters to decide what values and combinations of values provide best search results.

(5) In the preferred embodiment, in the detailed flow of processes for handling one search query (FIG. 5), the intent match search engine provides a search query interface (500) at which a user can enter a search query. The search query interface is a graphics based interface, and its appearance is shown in FIG. 1.

The implementer of the intent match search engine can also implement the search query interface as a sound based interface. Under some situations, because using a sound based input device is more appropriate, a sound based search query interface may be more appropriate than the graphics based search query interface. For example, using sound based input device on a cell phone, such as an Apple's iPhone, would be more appropriate than using the hand based input device which is the key pad on a simple cell phone or the virtual keyboard on the screen of an iphone. The reason is that, on most simple cell phones, one key button corresponds to multiple alphabetic letters which makes it time consuming to type in a search query. On more complicated cell phones, a single key button corresponds to a single alphabetic letter, but the key buttons are too small which makes it time consuming to type in a search query. On an iPhone, the displayed alphabetic letters on the screen are too small which also makes it time consuming to type in a search query. Thus, using sound based input devices on a cell phone would be more appropriate.

If the user input device is sound based, such as a microphone, then additional confirmations may be needed to identify user inputs. The reason is that sound inputs typically are realized through human oral languages. Due to the nature of human oral languages, such as different pronunciations and different accents for a same word, sound inputs usually are less accurate and more difficult to identify. Thus, for sound based inputs, extra work typically needs to be done to identify the inputs. For example, normally, an automatic telephone answering system often reads back a user's input and confirms that it determines the user's input correctly.

Even the user input device is a sound based input device, such as a microphone, the implementer of the intent match search engine may still provide the search query interface in the form of what is shown in FIG. 1. After receiving a search query, the intent match search engine may identify the user's input and place it in the input box (as shown in FIG. 1) for the user to confirm.

(6) In the preferred embodiment, in the detailed flow of processes for handling one search query (FIG. 5), there is the step for computing the overall ranks of the matched web pages at (560), and the overall ranks of the matched web pages are used at (570) to set the order in which to present the matched web pages to the user.

The implementer of the intent match search engine may choose to not compute overall ranks of the matched web pages and use a different method to set the order of the matched web pages at (570). The different method can be: Consider the relevance degrees first, consider the reliability degrees second and consider the historical degrees third. Below are the details.

Consider the relevance degrees first: Divide the interval (0, 1] into small intervals (0, 1-n*epsilon1], . . . , (1-3*epsilon1, 1-2*epsilon1], (1-2*epsilon1, 1-epsilon1], (1-epsilon1, 1], where epsilon1 is a very small number, such as epsilon1=0.001, and n is the positive integer such that n*epsilon1<1 and (n+1)*epsilon1≧1. Set the order of the matched web pages in groups: The first group contains the matched web pages whose normalized relevance degrees (nWPRelevD) fall into the small interval (1-epsilon 1, 1], the second group contains the matched web pages whose normalized relevance degrees fall into the small interval (1-2*epsilon1, 1-epsilon1], the third group contains the matched web pages whose normalized relevance degrees fall into the small interval (1-3*epsilon1, 1-2*epsilon1], and so on and so forth. The order of those groups is that the first group comes first, the second group comes second, the third group comes third, and so on and so forth.

After applying the filtering of the normalized relevance degrees, for the matched web pages that are in the same group, consider their reliability degrees: Divide the interval (0, 1] into small intervals (0, 1-m*epsilon2], . . . , (1-3*epsilon2, 1-2*epsilon2], (1-2*epsilon2, 1-epsilon2], (1-epsilon2, 1], where epsilon2 is a very small number, such as epsilon2=0.001, and m is the positive integer such that m*epsilon2<1 and (m+1)*epsilon2≧1. Set the order of the matched web pages in groups: The first group contains the matched web pages whose normalized reliability degrees (nWPReliaD) fall into the small interval (1-epsilon2, 1], the second group contains the matched web pages whose normalized reliability degrees fall into the small interval (1-2*epsilon2, 1-epsilon2], the third group contains the matched web pages whose normalized reliability degrees fall into the small interval (1-3*epsilon2, 1-2*epsilon2], and so on and so forth. The order of those groups is that the first group comes first, the second group comes second, the third group comes third, and so on and so forth.

After applying the filtering of the normalized reliability degrees, for the matched web pages that are in the same group, consider their historical degrees: Divide the matched web pages into two groups. The first group contains the matched web pages that have historical degrees with respect to the particular user and the particular search query (Have-historical-degree Group), and the second group contains the matched web pages that don't have historical degrees with respect to the particular user or the particular search query (Not-have-historical-degree Group). The order of those two groups is that the first group comes first and the second group comes second.

In the Not-have-historical-degree Group mentioned above, set their order according to whether or not they have matched abstracts: The group of matched web pages that have matched abstracts (Matched-abstract Group) comes first, and the group of matched web pages that don't have matched abstracts (No-matched-abstract Group) comes second.

Within the No-matched-abstract Group, set the order of the matched web pages according to the separation degrees of matches on the matched web pages: The smaller the separation degree, the earlier the matched web page. (Note that, for the matched web pages in this group, there are no matched abstracts. Thus, there must be matches on the web pages themselves.) If two or more matched web pages have the same separation degree of match, then set them in any order.

Within the Matched-abstract Group, set the order of the matched web pages according to the relevance degrees of the matches (MRD) in the Most Relevant Matched Abstracts that were associated with the web pages at (550) in FIG. 5: The higher the relevance degree, the earlier the matched web page. If two or more Most Relevant Matched Abstracts have the same relevance degree, then set their order according to whether or not there are matches on the web pages themselves: The group of matched web pages that have matches on the web pages themselves (Match-on-web-page Group) comes first, and the group of matched web pages that don't have matches on the web pages themselves (No-match-on-web-page Group) comes second.

Within the No-match-on-web-page Group, set the matched web pages in any order.

Within the Match-on-web-page Group, set the order of the matched web pages according to the separation degrees of matches on the matched web pages: The smaller the separation degree, the earlier the matched web page. If two or more matched web pages have the same separation degree of match on the web pages, then set them in any order.

In the Have-historical-degree Group mentioned above, consider the historical degrees of the matched web pages (nWPHistoD): Divide the interval (0, 1] into small intervals (0, 1-k*epsilon3], . . . , (1-3*epsilon3, 1-2*epsilon3], (1-2*epsilon3, 1-epsilon3], (1-epsilon3, 1], where epsilon3 is a very small number, such as epsilon3=0.001, and k is the positive integer such that k*epsilon3<1 and (k+1)*epsilon3≧1. Set the order of the matched web pages in groups: The first group contains the matched web pages whose historical degrees fall into the small interval (1-epsilon3, 1], the second group contains the matched web pages whose historical degrees fall into the small interval (1-2*epsilon3, 1-epsilon3], the third group contains the matched web pages whose historical degrees fall into the small interval (1-3*epsilon3, 1-2*epsilon3], and so on and so forth. The order of those groups is that the first group comes first, the second group comes second, the third group comes third, and so on and so forth.

For the matched web pages whose historical degrees fall into the same small interval, set the order of the matched web pages in the same way that the order of the matched web pages in the Not-have-historical-degree Group was set. See above for the details of how to set the order of the matched web pages in the Not-have-historical-degree Group.

Here, there are three small positive parameters epsilon1, epsilon2 and epsilon3. Currently, the preferred value of them is 0.001. However, epsilon1, epsilon2 and epsilon3 can have different values. Experiments should be done to see what values of them yield the best search results.

If an implementer of the intent match search engine chooses to use the above method to set the order of the matched web pages at (570), the step (560) in FIG. 5 is not needed. Then, after the intent match search engine computes the normalized relevance degrees of all the matched web pages at (550), it directly proceeds to (570) to set the order of the matched web pages.

(7) In the preferred embodiment, in the detailed flow of processes for handling one search query (FIG. 5), there is the step for computing the overall ranks of the exact matched web pages at (522), and the overall ranks of the exact matched web pages are used at (523) to set the order in which to present the exact matched web pages to the user.

The implementer of the intent match search engine may choose to not compute overall ranks of the exact matched web pages and use a different method to set the order of the exact matched web pages at (523). The different method can be: Consider the reliability degrees first and consider the historical degrees second. Below are details of the method.

Consider their reliability degrees first: Divide the interval (0, 1] into small intervals (0, 1-n*epsilon1], . . . , (1-3*epsilon1, 1-2*epsilon1], (1-2*epsilon1, 1-epsilon1], (1-epsilon1, 1], where epsilon1 is a very small number, such as epsilon1=0.001, and n is the positive integer such that n*epsilon1<1 and (n+1)*epsilon1≧1. Set the order of the exact matched web pages in groups: The first group contains the exact matched web pages whose normalized reliability degrees (nWPReliaD) fall into the small interval (1-epsilon1, 1], the second group contains the exact matched web pages whose normalized reliability degrees fall into the small interval (1-2*epsilon1, 1-epsilon1], the third group contains the exact matched web pages whose normalized reliability degrees fall into the small interval (1-3*epsilon1, 1-2*epsilon1], and so on and so forth. The order of those groups is that the first group comes first, the second group comes second, the third group comes third, and so on and so forth.

For the exact matched web pages that are in the same group, consider their historical degrees: Divide the exact matched web pages into two groups. The first group contains the exact matched web pages that have historical degrees with respect to the particular user and the particular search query (Have-historical-degree Group), and the second group contains the exact matched web pages that don't have historical degrees with respect to the particular user or the particular search query (Not-have-historical-degree Group). The order of those two groups is that the first group comes first and the second group comes the second.

In the Not-have-historical-degree Group mentioned above, set the order of the exact matched web pages in, any order.

In the Have-historical-degree Group mentioned above, consider the historical degrees of the exact matched web pages (nWPHistoD): Divide the interval (0, 1] into small intervals (0, 1-m*epsilon2], . . . , (1-3*epsilon2, 1-2*epsilon2], (1-2*epsilon2, 1-epsilon2], (1-epsilon2, 1], where epsilon2 is a very small number, such as epsilon2=0.001, and m is the positive integer such that m*epsilon2<1 and (m+1)*epsilon2≧1. Set the order of the exact matched web pages in groups: The first group contains the exact matched web pages whose historical degrees fall into the small interval (1-epsilon2, 1], the second group contains the exact matched web pages whose historical degrees fall into the small interval (1-2*epsilon2, 1-epsilon2], the third group contains the exact matched web pages whose historical degrees fall into the small interval (1-3*epsilon2, 1-2*epsilon2], and so on and so forth. The order of those groups is that the first group comes first, the second group comes second, the third group comes third, and so on and so forth.

For the exact matched web pages whose historical degrees fall into the same small interval, set the order of the exact matched web pages in any order.

. Here, there are two small positive parameters epsilon1 and epsilon2. Currently, the preferred value of them is 0.001. However, epsilon1 and epsilon2 can have different values. Experiments should be done to see what values of them yield the best search results.

If an implementer of the intent match search engine chooses to use the above method to set the order of the exact matched web pages at (523), then the step (522) in FIG. 5 is not needed. Then, after the intent match search engine finds exact matched web pages at (521), it directly proceeds to (523) to set the order of the exact matched web pages.

(8) In the preferred embodiment, in the detailed flow of processes for handling one search query (FIG. 5), when computing the overall ranks of the matched web pages at (560) and when computing the overall ranks of the exact matched web pages at (522), the historical degrees (nWPHistoD), if available, were taken into consideration. If the implementer of the intent match search engine doesn't want to consider users'historical search data, then the implementer can take the historical degrees out of the computations of the overall ranks of the matched web pages or the exact matched web pages. Then, the formulas for computing overall ranks for the case “Case 2” can be used to compute the overall ranks of all the matched web pages or the exact matched web pages. Under this situation, there is no need to compute historical degrees of the web pages that a user visited after he completes a search. In other words, “B-3: Compute Historical Degrees after Each Search” is not needed at all.

(9) In the preferred embodiment, in the detailed flow of processes for handling one search query (FIG. 5), for either looking for a match or computing the ranks of matched web pages, the titles of the web pages are not considered.

The implementer of the intent match search engine may choose to take into consideration titles of web pages when looking for a matched web page and when computing ranks of matched web pages. The processes can be similar to the processes in which the abstracts are used.

(10) In the preferred embodiment, in “B-2: Abstract the Web Pages”, for abstracting a web page, the references from other web pages about the web page X are used to generate abstracts. An alternative way is to use abstracting (or, summarizing) software to do the abstracting if/when such software is mature enough to give an accurate abstract for a document.

(11) In the preferred embodiment, in the detailed flow of processes for handling one search query (FIG. 5), there are the processes for checking input errors in the user's search query at (510), (511), (512) and (513). The implementer of the intent match search engine may choose not to do the input error checking. Then, after the intent match search engine receives a search query at (500), it will proceed directly to (520) to check whether the search is an exact match search request.

(12) In the preferred embodiment, in the detailed flow of processes for handling one search query (FIG. 5), at the step (520), the intent match search engine checks whether the match is an exact match request or not. The implementer of the intent match search engine may choose to not provide the exact match functionality. Then, after the intent match search engine receives a search query and corrects input errors (if any), it directly proceeds to (530) to perform syntax and semantics analysis of the search query and generate an intent match criterion that will be used to match the web pages.

(13) In the preferred embodiment, in the detailed flow of processes for handling one search query (FIG. 5), at the step (521), the intent match search engine checks where there are exact matches in the web page and doesn't consider at all whether there are exact matches in the abstracts of the web page. The implementer of the intent match search engine may choose to also check exact matches in the abstracts and taking the exact matches in the abstracts into consideration when decides whether a web page is an exact matched web page or not and when computes overall ranks of the exact matched web pages.

(14) In the preferred embodiment, in the detailed flow of processes for handling one search query (FIG. 5), at the step (540), if the intent match search engine doesn't find any matched web pages, the intent match search engine proceeds to (541) to check whether the match status is word match or intent match, and if the match status is intent match (that is, not word match), then the intent match search engine proceeds to (542) to generate a word match and then proceeds back to (540) to try to find matched web pages.

The implementer of the intent match search engine may choose to not have the step for checking the status of the match. Then, at (540), if the intent match search engine doesn't find any matched web pages, the intent match search engine immediately notifies the user and returns to the search query interface (500) for the user to enter a new search query.

(15) In the preferred embodiment, in the detailed flow of processes for handling one search query (FIG. 5), when displaying items about a matched web page at (580) or an exact matched web page at (524), only one abstract (if any) is displayed. An alternative method is to display more than one abstract, such as two or more abstracts if there are more than one abstract and if there is enough space for displaying the abstracts.

(16) In the preferred embodiment, in the detailed flow of processes for handling one search query (FIG. 5), when displaying items about a matched web page at (580) or an exact matched web page at (524), only one match (if any) on the web page is displayed. An alternative method is to display more than one match, such as two or more matches if there are so many matches, and if there is enough space for displaying the matches.

(17) In the preferred embodiment, in “B-3: Compute Historical Degrees after Each Search”, a user is identified by the IP address of the machine from which the search is performed. Different methods can be used to identify a user.

(18) In the preferred embodiment, in “B-3: Compute Historical Degrees after Each Search”, at step (440), when creating the Visited Web Pages List, the program Recorder only records the matched web pages that were presented to the user by the intent match search engine and that the user actually visited for a search. The implementer of the intent match search engine may choose to record all the web pages that the user actually visited for a search and place the web pages in the Visited Web Pages List.

(19) The intent match search engine may provide a “Cancel” feature in its search query interface. Then, a user can cancel the search at anytime before the intent match search engine presents any matched web pages.

### D. Conclusions, Ramifications and Scope of the Present Invention.

(1) Below is a summary of the advantages of the intent match search engine of the present invention comparing with the currently popular query based search engines, such as Google.

(Advantage—1) The criterion that the intent match search engine uses to match web pages to a search query has advantages.

By matching the user's real search intent instead of simply matching the words in the search query, the intent match search engine more likely will find web pages that contain what the user is really looking for.

(Advantage—2) The method that the intent match search engine uses to rank matched web pages has advantages.

By considering both the relevancy and reliability of the matched web pages (and actually even the user's historical search data) instead of considering only the reliability of the matched web pages, the intent match search engine more likely will give high rankings to the web pages that both contain the information that the user is looking for and are reliable sources of information. This saves the user's time, since the very first web page may already contain what the user is looking for and is also the most reliable source of information. The user doesn't need to navigate through a lot of matched web pages before he finds what he is looking for.

(Advantage—3) The method that the intent match search engine uses to present a matched web page has advantages.

When presenting a matched web page to the user, in addition to displaying a hyperlink to the web page and the match (if any) on that web page, the intent match search engine also displays an abstract of the web page (if any) which tells the user what that web page is mainly about. With the additional information of the abstract, without the need to actually navigate through the web page, the user is more likely able to judge whether the web page contains what he is looking for. This saves the user's time.

(Advantage—4) The intent match search engine is able to provide advertisements that more likely are relevant to the user's needs.

The intent match search engine analyzes the user's search query to determine what the user is really looking for. Thus, the intent match search engine knows the user's needs. With this knowledge, the intent match search engine will be able to provide the advertisements that more likely are relevant to the user's needs.

(2) As already stated, it should be understood that using query based web search engines as an embodiment of query based search engine is solely for the sake of descriptions and explanations. It should not be construed as limiting the scope of the present invention. Those skilled in the art may apply the present invention to or implement the present invention with any query based search engines aimed at searching a database of linked documents.

(3) As already stated, it should be understood that using word match web search engines as representative of query based web search engines is solely for the sake of illustrations, and for the sake of comparing the disadvantages of the currently popular query based web search engines and the corresponding advantages of the intent match search engine of the present invention. It should not be construed as limiting the scope of the present invention. Those skilled in the art may apply the present invention to or implement the present invention with any query based web search engines.

(4) As already stated, it should be understood that using Google as a representative of word match web search engines is solely for the sake of illustrations, and for the sake of comparing the disadvantages of the currently popular word match web search engines and the corresponding advantages of the intent match search engine of the present invention. It should not be construed as limiting the scope of the present invention. Those skilled in the art may apply the present invention to or implement the present invention with any word match web search engines.

(5) It should be understood that the above descriptions (including but not limited to all the embodiments and their variations, and examples) are meant to be illustrative of the principles and various embodiments of the present invention. The above descriptions should not be construed as limiting the scope of the present invention. Numerous variations and modifications (including but not limited to various changes, adding similar parts or steps, taking off parts or steps, modifying parts or steps, substitutions and alterations) will become apparent to those skilled in the art once the above disclosure is fully appreciated, and such constructions do not depart from the spirit and scope of the present invention.

The scope of the invention should be determined by the appended claims and their legal equivalents and extensions, and not by the embodiments, variations or examples given.

I claim:

1. A method for a query based search engine that searches a database of linked documents, comprising:
(1.a) computing reliability degrees of the documents;
(1.b) abstracting each document to generate its abstracts;
(1.c) providing a search query interface so that a user can use to enter a search query;
(1.d) processing the search query to generate an intent match criterion;
(1.e) identifying matched documents according to the generated intent match criterion;
(1.f) computing relevance degrees of the matched documents;
(1.g) setting order of the matched documents; and
(1.h) presenting the matched documents to the user according to the set order by displaying the following items for each matched document: a link to the matched document, an abstract of the matched document if there are abstracts of the matched document, and a match in the matched document if there are matches in the matched document.

2. The method of claim 1, wherein said abstracting each document to generate its abstracts comprises utilizing cross references among the documents to generate the abstracts.

3. The method of claim 1, wherein said processing the search query to generate an intent match criterion comprises performing syntax and semantics analysis to generate the intent match criterion.

4. The method of claim 1, wherein said identifying matched documents comprises taking a document as a matched document if there is a match in an abstract of the document or there is a match in the document itself.

5. The method of claim 4, further comprising, for each matched document:
(5.a) identifying all matches in each abstract of the matched document;
(5.b) computing separation degrees of all the matches in that particular abstract;
(5.c) taking a match in that particular abstract that has the least separation degree of the separation degrees of all the matches in that particular abstract as the match in that particular abstract, and taking the least separation degree of the separation degrees of all the matches in that particular abstract as the separation degree of the match in that particular abstract;
(5.d) identifying all matches in the matched document itself;
(5.e) computing separation degrees of all the matches in the matched document itself; and
(5.f) taking a match in the matched document itself that has the least separation degree of the separation degrees of all the matches in the matched document itself as the match in the matched document itself, and taking the least separation degree of the separation degrees of all the matches in the matched document itself as the separation degree of the match in the matched document itself.

6. The method of claim 5, wherein said computing relevance degrees of the matched documents comprises, for each matched document:
(6.a) computing relevance degrees of all matches in abstracts of the matched document and the match in the matched document itself; and
(6.b) taking the largest relevance degree of all the relevance degrees of all the matches in abstracts of the matched document and the match in the matched document itself as the relevance degree of the matched web page.

7. The method of claim 6, wherein said computing relevance degrees of all matches comprises, for each match:
(7.a) computing a location match degree of the match;
(7.b) computing an intent match degree of the match; and
(7.c) computing the relevance degree of the match based on the location match degree and the intent match degree.

8. The method of claim 7, wherein said computing an intent match degree of the match comprises computing the intent match degree based on separation degree of the match.

9. The method of claim 1, wherein said setting order of the matched documents comprises setting the order based on the relevance degrees and reliability degrees of the matched documents.

10. The method of claim 1, further comprising computing historical degrees of all documents that the user visited after the user completes a particular search with a particular search query.

11. The method of claim 10, wherein said setting order of the matched documents comprises setting the order based on the relevance degrees and reliability degrees of the matched documents, and, if any, historical degrees of the matched documents with respect to the user and with respect to the search query.

12. A query based search engine that searches a database of linked documents, comprising:
(12.a) first means for computing reliability degrees of the documents;
(12.b) second means for abstracting each document to generate its abstracts;
(12.c) a search query interface so that a user can use to enter a search query;
(12.d) third means for processing the search query to generate an intent match criterion;
(12.e) fourth means for identifying matched documents according to the generated intent match criterion;
(12.f) fifth means for computing relevance degrees of the matched documents;
(12.g) sixth means for setting order of the matched documents; and
(12.h) seventh means for presenting the matched documents to the user according to the set order by displaying the following items for each matched document: a link to the matched document, an abstract of the matched document if there are abstracts of the matched document, and a match in the matched document if there are matches in the matched document.

13. The query based search engine of claim 12, wherein said second means comprises eighth means for utilizing cross references among the documents to generate the abstracts.

14. The query based search engine of claim 12, further comprising, for each matched document:
(14.a) ninth means for identifying all matches in each abstract of the matched document;
(14.b) tenth means for computing separation degrees of all the matches in that particular abstract;
(14.c) eleventh means for identifying the match in that particular abstract and the separation degree of the match in that particular abstract;
(14.d) twelfth means for identifying all matches in the matched document itself;
(14.e) thirteenth means for computing separation degrees of all the matches in the matched document itself; and
(14.f) fourteenth means for identifying the match in the matched document itself and the separation degree of the match in the matched document itself.

15. The query based search engine of claim 14, wherein said fifth means comprises, for each matched document:
(15.a) fifteenth means for computing relevance degrees of all matches in abstracts of the matched document and the match in the matched document itself; and
(15.b) sixteenth means for identifying the relevance degree of the matched web page.

16. The query based search engine of claim 12, wherein said sixth means comprises seventeenth means for setting the order based on the relevance degrees and reliability degrees of the matched documents.

17. The query based search engine of claim 12, further comprising eighteenth means for computing historical degrees of all documents that the user visited after the user completes a particular search with a particular search query.

18. The query based search engine of claim 17, wherein said sixth means comprises nineteenth means for setting the order based on the relevance degrees and reliability degrees of the matched documents, and, if any, historical degrees of the matched documents with respect to the user and with respect to the search query.

19. A method for abstracting a document in a database of linked documents to generate abstracts of the document comprising utilizing cross references among the documents to generate the abstracts.

20. A method for presenting a matched document to a user of a query based search engine that searches a database of linked documents comprising displaying the following items for the matched document: a link to the matched document, an abstract of the matched document if there are abstracts of the matched document, and a match in the matched document if there are matches in the matched document.
